(19) United States
(12) Patent Application Publication
(10) Pub. No.: US 2009/0010603 A1
(43) Pub. Date: Jan. 8, 2009

(54) Resin Composition for Optical Packaging Material and Process for Preparing the Same, and Optical Packaging Material, Optical Packaging Component, and Optical Module

(76) Inventors: Takuo Sugioka, Suita-shi (JP); Yasunori Tsujino, Takatsuki-shi (JP); Kozo Tajiri, Suita-shi (JP); Yoshinobu Asako, Nishinomiya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/664,818

(22) PCT Filed: Oct. 7, 2005
(86) PCT No.: PCT/JP05/18903

§ 371 Date: Apr. 6, 2007

(30) Foreign Application Priority Data
Oct. 7, 2004 (JP) 2004-295346
Jul. 1, 2005 (JP) 2005-194372

(51) Int. Cl. G02B 6/00; C08K 3/00; G02B 6/02

(52) U.S. Cl. 385/123; 524/401; 385/143; 385/145

(57) ABSTRACT

To provide to a resin composition for an optical packaging material having a coefficient of thermal expansion approximately same as that of quartz and Pyrex (registered trade name) and capable of providing an optical packaging material exhibiting excellent flame retardancy and an optical packaging component, and an optical module and its production method. A molded body, an optical packaging component and an optical module having a low coefficient of thermal expansion and excellent flame retardancy can be obtained using a resin composition for an optical packaging material comprising a resin and inorganic fine particles which are made of a hydrolyzed condensate compound of an alkoxide compound and/or a carboxylic acid salt compound and have an average radius of gyration of 50 nm or smaller.

### TECHNICAL FIELD

The present invention relates to an optical packaging component to be used for optical fiber communication and an optical module as well as an optical packaging material suitable therefor, and a resin composition for an optical packaging material.

### DESCRIPTION OF RELATED ART

Today, along with the wide spread of internet, high speed communication service “FTTH (Fiber to the home)” connecting an optical fiber capable of transmitting a large capacity of information by optical signals to the home is being provided. As a method for connecting optical fibers to respective homes has been employed a method of splitting optical signals sent from a station side by an optical splitter and thereby connecting the station side and respective homes in one-to-multi connection manner.

In an optical fiber network for connecting a transmission station of optical signals to respective homes in one-to-multi connection manner, besides optical fibers, an optical connector for connecting optical fibers and an optical module as a component for splitting optical signals in the station side have been becoming popular. As shown in FIG. 1, the optical module comprises optical packaging components such as a one-channel optical fiber array 1, an optical waveguide 3, and a multi-channel optical fiber array 1′ as shown in FIG. 1.

FIG. 2 shows an enlarged perspective view of the multi-channel optical fiber array 1′ of FIG. 1. A substrate 7 for the optical fiber array is formed with a V-shaped groove 9 for placing an optical fiber 5, and the optical fiber 5 is laid therein.

Generally, a substrate of the optical fiber array and an optical waveguide is made of a hard inorganic material such as quartz and Pyrex (registered trade name). In the case of forming a space (a groove) for placing an optical fiber in an optical fiber array substrate made of such a hard material, a method of forming a substrate previously and carrying out mechanical processing such as grinding and polishing to form a groove or a method of molding molten glass by a die has been employed but either method is not suitable enough to give a processing precision in several μm level. Therefore, an optical module comprising an optical fiber array made of quartz, Pyrex (registered trade name), an optical waveguide, and an optical fiber is very expensive and it is required to produce an optical module by mass production and supply it at a low price from the view point of further spreading the optical fiber network.

Under these circumstances, it has been investigated to replace a part of a substrate constituting an optical fiber array with an article made of a resin composition (for example, Japanese Patent Publication No. 2002-236233 A and Japanese Patent Publication No. 2003-107283 A). Japanese Patent Publication No. 2002-236233 A discloses an optical fiber array comprising a substrate where a resin layer having a plurality of grooves is formed and optical fibers are placed in the grooves. Japanese Patent Publication No. 2003-107283 A discloses a micro hole array provided with a plurality of holes for plugging or holding optical fibers or lenses therein, comprising a plurality of cylindrical parts having the holes and a main body substrate formed closely to the entire circumferential faces or portions of the circumferential faces of the cylindrical parts, and characterized in that the cylindrical parts are made of a resin and the main body substrate is made of any one of a ceramic, glass, a metal or their composite.

On the other hand, with respect to a technique relevant to an optical waveguide device made of a polymer material, there are, for example, Japanese Patent Publication No. H08-313747 A and Japanese Patent Publication No. 2001-318257 A. Japanese Patent Publication No. H08-313747 A discloses a method of producing a polymer optical waveguide comprising at least a core made of a polymer material and a clad surrounding the core and made of a material having a refractive index lower than that of the core. The method comprises the steps of obtaining a lower part clad by putting a clad material on a die having continuously projected parts partially in a flat face in a manner that the surface of the clad material is made flat; putting a flat substrate on the lower part clad; turning the resulting unit upside down so as to set the flat substrate in the lower side; removing the die; putting a core material in the grooves formed in the portions corresponding to the projected parts of the die; removing the portions of the core material overflowed from the grooves; putting the clad material on the lower part clad so as to cover the core; and removing the flat substrate.

Japanese Patent Publication No. 2001-318257 A discloses a process for producing a ridge type polymer optical waveguide. The process comprises the steps of producing a die in which a sacrifice layer for separating a polymer and a substrate on the substrate which has projected and recessed shapes to be a core part of the optical waveguide, applying a polymer to be the core in a melt or solution state; curing the polymer by ultraviolet rays or heat; further applying a polymer to be a lower clad in a melt or solution state thereto; curing the polymer; and then separating the die by removing the sacrifice layer.

### DISCLOSURE OF THE INVENTION

An optical module comprising an optical waveguide and an optical fiber array is required to transmit optical signals without shift of an optical axis even in a high temperature and humidity test at 85° C. and 85 RH and a heat cycle test between 85° C. and −40° C. according to Telcordial standard. As compared with inorganic materials such as quartz and Pyrex (registered trade name), conventional optical packaging materials made of resin compositions have high coefficients of thermal expansion and therefore, even if the optical axes are adjusted at a normal temperature, there is a problem that the shift of the optical axes occurs due to the difference of the expansion ratios between at 85° C. and −40° C. and that optical signals are not transmitted. For this reason, optical packaging materials of resin compositions which are practically usable are not made available in the present situation. Further, optical packaging materials for optical communication are required to have flame retardancy. In order to exhibit flame retardancy, it is necessary to add halogen type, phosphorus type, or antimony type flame retardants, which causes heavy loads on environments, to resins. However, the above-mentioned Japanese Patent Publication No. 2002-236233 A does not have any description of flame retardants to be added to the resin compositions and therefore, it cannot be said that the flame retardancy sufficient enough to replace the ceramic type optical packaging component with a polymer material type is ensured. Also, halogen type flame retardants are used for the resin compositions disclosed in Japanese Patent Publication No. 2003-107283 A, however use of these flame retardants is undesirable in terms of protecting the natural environment.

The present invention has been achieved in view of the above circumstances, it is an object of the present invention to provide an innovative resin composition for an optical packaging material which has an approximately same coefficient of thermal expansion as those of quartz and Pyrex (registered trade name), exhibits excellent flame retardancy, and is useful for producing an optical packaging material, an optical packaging component, and an optical module and a method for producing the resin composition.

Another object of the present invention is to provide a resin composition for an optical packaging material preferably usable for an optical waveguide and an optical waveguide device using the same.

The present invention, having solved the above-mentioned problems, provides a resin composition for an optical packaging material comprising a resin and an inorganic fine particle, wherein the inorganic fine particle is a hydrolyzed condensate of an alkoxide compound and/or a carboxylic acid salt compound and has an average inertia radius of 50 nm or smaller. In other words, the gist of the present invention is that the inorganic fine particle which is a hydrolyzed condensate of an alkoxide compound and/or a carboxylic acid salt compound and has an average inertia radius of 50 nm or smaller in a nano-level is dispersed in a resin, thereby lowering the coefficient of the thermal expansion of the resultant optical packaging material and providing flame retardancy. As a preferable resin is a thermosetting resin or a photocurable resin.

In a preferable embodiment of the resin composition for the optical packaging material of the present invention, the resin composition further contains 2% (inclusive) to 95% (exclusive) by weight of an inorganic compound having an average particle size of 0.1 μm to 100 μm. Use of the inorganic compound in combination improves the effect of the inorganic fine particle on the flame retardancy, the thermal property, (coefficient of thermal expansion), and the mechanical property of a molded product to a higher extent.

The present invention also includes an optical packaging material and a molded body obtained by curing the above resin composition for the optical packaging material. The molded body preferably has a coefficient of thermal expansion of 80 ppm or lower at a temperature of a glass transition temperature or lower.

The present invention also includes a halogen-free resin molded body for an optical packaging material, having flame retardancy of V-1 or higher defined by UL-94 and a coefficient of thermal expansion of 80 ppm or lower at a temperature of a glass transition temperature or lower thereof.

The present invention includes an optical packaging component using the above-mentioned optical packaging material and/or its molded body. The optical packaging component is preferably an optical fiber array, a micro hole array, or an optical waveguide device.

The present invention also includes an optical module comprising the above-mentioned optical packaging component.

The present invention provides a method for preparing a molded body of an optical packaging material comprising, pressure molding a resin composition for an optical packaging material comprising a resin and an inorganic fine particle wherein the inorganic fine particle is a hydrolyzed condensate of an alkoxide compound and/or a carboxylic acid salt compound and has an average inertia radius of 50 nm or smaller.

The present invention also provides an optical waveguide device comprising an optical waveguide having a core and a clad covering the core, wherein at least one of the core and the clad is formed by curing the above resin composition for the optical packaging material.

According to the present invention, the coefficients of thermal expansion of the optical packaging material and the molded body thereof to be obtained can be controlled and the optical packaging material and the molded bodies having the coefficients of thermal expansion approximately same as those of quartz and Pyrex (registered trade name) can be obtained.

Also, the present invention provides the optical packaging material, the molded bodies thereof, the optical packaging component, and the optical module comprising the component which has sufficient flame retardancy for the optical packaging materials without using halogen type, phosphorus type, or antimony type flame retardants which causes heavy loads on environments.

According to the production process of the present invention, the molded body of the optical packaging material can be produced by press molding and the V-shaped groove can easily be formed in the optical fiber array substrate. Also, the processing can be carried out at a temperature as low as 50 to 250° C. and is economical since it is not necessary to carry out the processing at a temperature as high as about 1000° C. which is required to produce a conventional quartz substrate.

The resin composition for the optical packaging material of the present invention is also suitable for the optical waveguide. The resulting refractive indexes of the core and the clad can be controlled by adjusting the content of the inorganic fine particle in the resin composition for the optical packaging material. Since the resin components of the optical packaging material to be used for the core and the clad are same, an optical waveguide having a good adhesion between the core and the clad and high reliability is obtained.

### BRIEF DESCRIPTION OF DRAWINGS

FIG. 1 is a plane view of an optical module comprising an optical fiber array and an optical waveguide;

FIG. 2 is an enlarged perspective view of an optical fiber array;

FIG. 3 is an explanatory drawing exemplifying an optical fiber array of the present invention;

FIG. 4 is a modified example of an optical fiber array of the present invention;

FIG. 5 is an explanatory drawing (a side view) exemplifying an optical waveguide of the present invention;

FIG. 6 is an explanatory drawing (a front view) exemplifying an optical waveguide device of the present invention; and

FIG. 7 is an explanatory drawing exemplifying an optical module of the present invention.

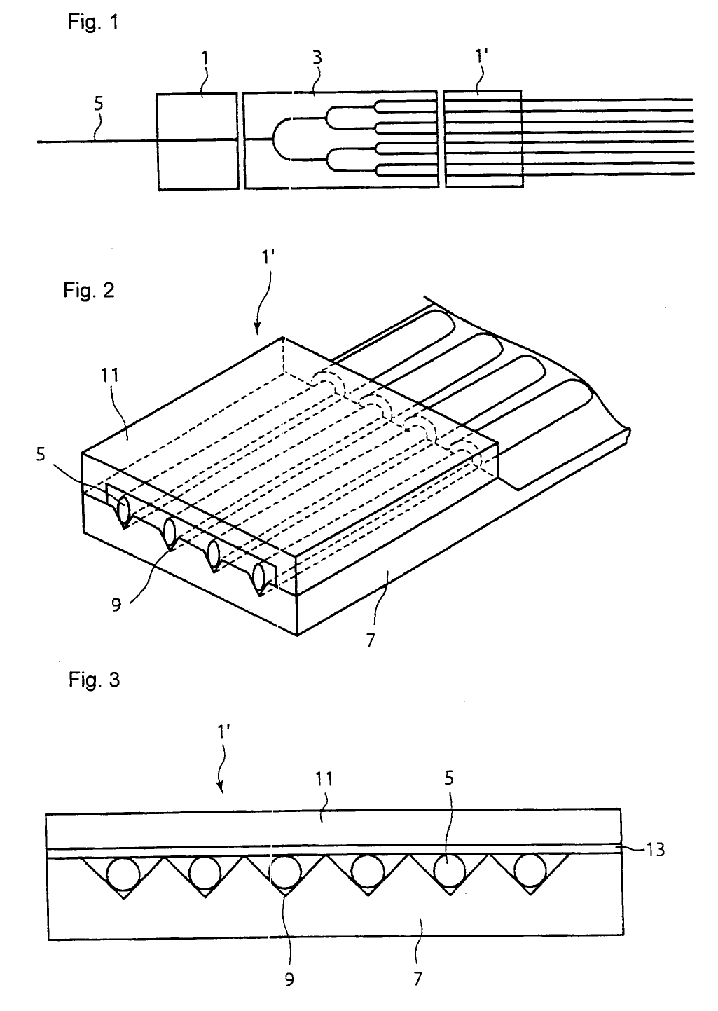

### BEST MODES FOR CARRYING OUT THE INVENTION

The resin composition of the optical packaging material of the present invention comprises a resin and an inorganic fine particle, wherein the inorganic fine particle is a hydrolyzed condensate of an alkoxide compound and/or a carboxylic acid salt compound and has an average inertia radius of 50 nm or smaller.

Hereinafter, the invention will be more described in detail.

### (1) With Respect to Resin

First of all, a resin which the resin composition for the optical packaging material of the present invention contains will be described. The resin contained in the resin composition of the present invention preferably includes a curable resin, more preferably a thermosetting resin or a photocurable resin.

The “curable resin” in the present invention is not limited as long as it is curable and contains a resin having a molecular weight from that of an oligomer to high molecular weight. The curable resin includes for example a curable resin in liquid or solid state; a mixture of the curable resin in liquid or solid state with either a curable compound having a molecular weight lower than that of the curable resin or a solvent (non-curable); and a mixture of a non-curable resin in liquid or solid state with a curable compound having a molecular weight lower than that of the resin component. Examples of the mixture of a non-curable resin in liquid or solid state with a curable compound having a molecular weight lower than that of the resin component include a mixture of an oligomer component of an acrylic resin such as PMMA with (meth)acrylate monomer.

In the present invention, as the above-mentioned curable resin, for example, a polyhydric phenol compound, a compound having a polymerizable unsaturated bond, or a compound having at least one glycidyl group and/or epoxy group are preferably used. These compounds may be used alone or as a mixture of at least two of them. Hereinafter, it will be described more in detail.

### (1-1) With Respect to Polyhydric Phenol Compound

The polyhydric phenol compound preferably includes a compound having a structure where aromatic backbones each having at least one phenolic hydroxyl group are bonded with an organic backbone having two or more carbon atoms. The aromatic backbone in the polyhydric phenol compound is defined as an aromatic ring having at least one phenolic hydroxyl group. The aromatic backbone is a portion having phenol type structure and the like. Preferable examples of the aromatic backbone and the like are a phenol type, a hydroquinone type, a naphthol type, an anthracenol type, a bisphenol type, a biphenol type and the like. Among them, the phenol type is preferable. The portion having the phenol type structure and the like may adequately be substituted with an alkyl group, an alkylene group, an aralkyl group, a phenyl group, and a phenylene group and the like.

With respect to the above-mentioned polyhydric phenol compound, the organic backbone is defined as a portion essentially containing a carbon atom and bonding the aromatic ring backbones each other constituting the polyhydric phenol compound. The organic backbone having two or more carbon atoms preferably has a ring structure. The ring structure includes a structure having a ring such as an aliphatic ring and an aromatic ring. Preferable examples of the ring are a cyclopentane ring, a cyclohexane ring, a benzene ring, a naphthalene ring, and an anthracene ring. Further, the organic backbone includes a ring structure and/or an aromatic ring containing a nitrogen atom such as a triazine ring, a phosphazene ring and the like. Among them, the triazine ring and/or the aromatic ring are preferable. The polyhydric phenol compound may further have an aromatic backbone or an organic backbone other than the above-exemplified ones. The polyhydric phenol compound may have a structure where the aromatic backbones each having at least one phenolic hydroxyl group are bonded with an organic backbone having one carbon (methylene) at the same time.

The polyhydric phenol compound preferably has a nitrogen atom content ranging from 1% to 50% by weight in the case that the polyhydric phenol compound has a ring structure containing a nitrogen atom as the organic backbone. If the content is lower than 1% by weight, the flame retardancy of the resultant optical packaging material may be insufficient, and if the content exceeds 50% by weight, the physical property and the flame retardancy cannot possibly be satisfied together. The content is more preferably from 3% to 30% by weight, even more preferably from 5% to 20% by weight. The nitrogen atom content is the weight ratio of a nitrogen atom constituting the polyhydric phenol compound on the basis of 100% by weight of the polyhydric phenol compound.

The polyhydric phenol compound to be used in the present invention is preferably produced from a reaction raw material containing a compound which forms the aromatic backbone having at least one phenolic hydroxyl group (hereinafter, referred to as “an aromatic backbone forming compound” in some cases) and a compound which forms the organic backbone having two or more carbon atoms (hereinafter, referred to as “a organic backbone forming compound” in some cases) as essential components.

The raw material of the above-mentioned reaction means a mixture containing the aromatic backbone forming compound and the organic backbone forming compound as essential components and, if necessary, other compounds, and a solvent and the like which are necessary to carry out the reaction. One or at least two of the aromatic backbone forming compound and the organic backbone forming compound may be used, respectively.

The above-mentioned aromatic backbone forming compound includes a compound where one or more phenolic hydroxyl groups are bonded to the aromatic ring. One or more substituent groups other than hydroxyl groups may be bonded to the aromatic ring. The aromatic backbone forming compound includes phenol, o-cresol, m-cresol, p-cresol, o-ethylphenol, p-ethylphenol, mixed cresol, p-hydroxyethylphenol, p-n-propylphenol, o-isopropylphenol, p-isopropylphenol, mixed isopropylphenol, o-sec-butylphenol, m-tert-butylphenol, p-tert-butylphenol, pentylphenol, p-octylphenol, p-nonylphenol, 2,3-dimethylphenol, 2,4-dimethylphenol, 2,6-dimethylphenol, 3,4-dimethylphenol, 2,4-di-sec-butylphenol, 3,5-dimethylphenol, 2,6-di-sec-butylphenol, 2,6-di-tert-butylphenol, 3-methyl-4-isopropylphenol, 3-methyl-5-isopropylphenol, 3-methyl-6-isopropylphenol, 2-tert-butyl-4-methylphenol, 3-methyl-6-tert-butylphenol, and 2-tert-butyl-4-ethylphenol. The compound having two or more phenolic hydroxyl groups includes, for example, catechol, resorcin, biphenol, bisphenol A, bisphenol S, and bisphenol F and the like and a compound forming polycyclic aromatic backbone such as α-naphthol and β-naphthol.

The above-mentioned organic forming compound preferably includes (1) an aromatic compound having any one of an α-hydroxyalkyl group, an α-alkoxyalkyl group, and an α-acetoxyalkyl group; (2) a compound having an unsaturated bond; (3) a compound having a carbonyl group such as aldehydes, ketones and the like; (4) a compound having two or more types of the above specified active groups or active portions; and (5) a compound having any one of an amino group, a hydroxyalkylamino group, and a di(hydroxyalkyl)amino group.

Examples of the aromatic compound (1) are p-xylylene glycol, p-xylylene glycol dimethyl ether, p-diacetoxymethylbenzene, m-xylylene glycol, m-xylylene glycol dimethyl ether, m-diacetoxymethylbenzene, p-dihydroxyisopropylbenzene, p-dimethoxyisopropylbenzene, p-diacetoxyisopropylbenzene, trihydroxymethylbenzene, trihydroxyisopropylbenzene, trimethoxymethylbenzene, trimethoxyisopropylbenzene, 4,4′-hydroxymethylbiphenyl, 4,4′-methoxymethylbiphenyl, 4,4′-acetoxymethylbiphenyl, 3,3′-hydroxymethylbiphenyl, 3,3′-methoxymethylbiphenyl, 3,3′-acetoxymethylbiphenyl, 4,4′-hydroxyisopropylbiphenyl, 4,4′-methoxyisopropylbiphenyl, 4,4′-acetoxyisopropylbiphenyl, 3,3′-hydroxyisopropylbiphenyl, 3,3′-methoxyisopropylbiphenyl, 3,3′-acetoxyisopropylbiphenyl, 2,5-hydroxymethylnaphthalene, 2,5-methoxymethylnaphthalene, 2,5-acetoxymethylnaphthalene, 2,6-hydroxymethylnaphthalene, 2,6-methoxymethylnaphthalene, 2,6-acetoxymethylnaphthalene, 2,5-hydroxyisopropylnaphthalene, 2,5-methoxyisopropylnaphthalene, 2,5-acetoxyisopropylnaphthalene, 2,6-hydroxyisopropylnaphthalene, 2,6-methoxyisopropylnaphthalene, and 2,6-acetoxyisopropylnaphthalene.

Examples of the compound having an unsaturated bond (2) are divinylbenzene, diisopropenylbenzene, trivinylbenzene, triisopropenylbenzene, dicyclopentadiene, norbornene, and terpenes. Examples of the compound having a carbonyl group (3) are various kinds of aldehydes and ketones having 5 to 15 carbon atoms and preferable examples are benzaldehyde, octanal, cyclohexanone, acetophenone, hydroxybenzaldehyde, hydroxyacetophenone, crotonaldehyde, cinnamaldehyde, glyoxal, glutaraldehyde, terephthalaldehyde, cyclohexanedialdehyde, tricyclodecanedialdehyde, norbornanedialadehyde, and suberaldehyde.

As the compound having a carbonyl group and an unsaturated bond, the above-mentioned compound having two or more types of the above specified active groups or active portions (4) includes, for example, isopropenylbenzaldehyde, isopropenylacetophenone, citronellal, citral, and perillaldehyde. Preferable examples of the compound having an α-hydroxyalkyl group or an α-alkoxyalkyl group and an unsaturated bond are dihydroxymethylstyrene, dihydroxymethyl-α-methylstyrene, dimethoxymethylstyrene, dimethoxymethyl-α-methylstyrene, hydroxymethyldivinylbenzene, hydroxymethyldiisopropylbenzene, methoxymethyldivinylbenzene, and methoxymethyldiisopropylbenzene.

The above-mentioned compound (5) having any one of an amino group, a hydroxyalkylamino group, and a di(hydroxyalkyl)amino group includes, for example, melamine, dehydroxymethylmelamine, trihydroxymethylmelamine, acetoguanamine, dihydroxymethylacetoguanamine, tetrahydroxymethylacetoguanamine, benzoguanamine, dihydroxymethylbenzoguanamine, tetrahydroxymethylbenzoguanamine, urea, dihydroxymethylurea, tetrahydroxymethylurea, ethylenediamine, dihydroxymethylethylenediamine, tetrahydroxymethylethylenediamine, hexaethylenediamine, dihydroxymethylhexaethylenediamine, tetrahydroxymethylhexaethylenediamine, p-xylylenediamine, p-dihydroxymethylaminobenzene, m-xylylenediamine, m-dihydroxymethylaminobenzene, 4,4′-oxydianiline, 4,4′-oxydihydroxymethylaniline, 4,4′-methylenedianiline, and 4,4′-methylenedihydroxymethylalinine. Among them, a compound and the like having a triazine backbone such as melamine, benzoguanamine, and acetoguanamine are preferable.

The above-mentioned reaction raw material preferably includes the aromatic backbone forming compound (hereinafter, referred to as a raw material A in some cases) and at least one kind of the organic backbone forming compound of the above-mentioned (1) to (5) (hereinafter, referred to as a raw material B in some cases) as essential components. More preferably, the reaction raw material includes the raw material A, at least one kind of the organic backbone forming compound among the above-mentioned (1) to (4) (hereinafter, referred to as a raw material B1 in some cases), and the organic backbone forming compound of the above-mentioned (5) (hereinafter, referred to as a raw material B2 in some cases) as essential components. In this case, preferable reaction order of the reaction raw material is as follows:

a) The raw material A, raw material B1, and raw material B2 are previously mixed and the raw material B2 are reacted before the completion of reaction between the raw material A and raw material B1. For example, either the raw material A, the raw material B1 and the raw material B2 are simultaneously reacted or the raw material A and raw material B2 are reacted in a first stage and then the raw material B1 is reacted in a second stage. Consequently, the flame retardancy can be reliably improved and the reaction products can be preferably used for molding materials for electronic materials and the like, adhesives, coating materials and the like. More preferably, the raw material A and the raw material B2 are reacted in the first stage and then the raw material B1 is reacted in the second stage.

The mixing mole ratio of the raw material A and the raw material B to be used for producing the above-mentioned polyhydric phenol compound is preferably 1/1 or higher and 10/1 or lower. If the mole ratio of the raw material A is lower than 1/1, gelation may possibly occur at the time of producing the resin composition for the optical packaging material of the present invention and if the mole ratio of the raw material A is more than 10/1, the flame retardancy of the resin composition is possibly hardly exhibited. The mixing mole ratio is more preferably 1.3/1 or higher and 8/1 or lower since the resin composition for the optical packaging material can exhibit higher strength at a high temperature. The mixing mole ratio is even more preferably 1.8/1 or higher and 5/1 or lower.

The above-mentioned polyhydric phenol compound is preferably obtained by reacting the above-mentioned reaction raw material in the presence of a catalyst. The catalyst usable for the production of the polyhydric phenol compound is not particularly limited as long as it can react the above-mentioned reaction raw material. In the case of reacting the raw material B1, examples of the preferable acid catalyst are an inorganic acid such as hydrochloric acid, sulfuric acid, phosphoric acid, p-toluenesulfonic acid, and methanesulfonic acid; and an organic sulfonic acid; as well as a super strong acid such as boron trifluoride or the complexes thereof, trifluoromethanesulfonic acid and heteropoly acid; and a solid acid catalyst such as active kaolin; a synthetic zeolite, a sulfonic acid-type ion exchange resin, and perfluoroalkanesulfonic acid type ion exchange resin. The amount of the catalyst used in the case of reacting the raw material B1 may properly be determined depending on the acidity thereof, it is preferably 0.001 to 100% by weight to the raw material B1. As the catalyst suitable for a homogeneous system in the above-mentioned range, trifluoromethanesulfonic acid, methanesulfonic acid, and boron trifluoride are preferable. The amount of them is preferably 0.001 to 5% by weight. The amount of the ion exchange resin and active kaolin and the like in heterogeneous system is preferably 1 to 100% by weight.

In the case of reacting the raw material B2, examples of the basic catalyst are a hydroxide of an alkali metal and an alkaline earth metal such as sodium hydroxide, potassium hydroxide, and barium hydroxide; ammonia; primary to tertiary amines; hexamethylenetetramine; and sodium carbonate. Examples of the preferable acid catalysts are an inorganic acid such as hydrochloric acid, sulfuric acid, and sulfonic acid; an organic acid such as oxalic acid and acetic acid; Lewis acid; and a basic catalyst of a divalent metals salt and the like such as zinc acetate. It is preferable to remove impurities such as salts by neutralization and washing with water, if necessary after reaction of raw material B2. In the case of using the amine as the catalyst, it is not preferable to remove impurities by neutralization or washing with water.

The polyhydric phenol compound is obtained by condensation of the aromatic ring of the raw material A and the substituent group of the raw material B and at that time. At this time, a carboxylic acid, an alcohol, and water, etc. are produced as byproducts together with the polyhydric phenol compound. The above carboxylic acid, the alcohol, and water as byproducts can be removed readily from the reaction product by stripping in reduced pressure and by azeotropic distillation with a solvent during or after the reaction without requiring complicated process. The term “reaction product” used herein means a mixture containing all the compounds obtained by carrying out the reaction as described above and thus includes the polyhydric phenol compound, the carboxylic acid, the alcohol, and water produced as byproducts, and may also include the catalyst and the solvent described later, which are used if necessary.

In the reaction condition in the production of the above-mentioned polyhydric phenol compound, the reaction temperature is preferably 100 to 240° C. where the carboxylic acid, the alcohol, and water, etc. produced as byproducts are evaporated and removed by distillation, more preferably 110 to 180° C., and even more preferably 130 to 160° C. In this way, although the carboxylic acid, etc. are produced as byproducts in the case of producing the polyhydric phenol compound, it is possible to remove the carboxylic acid, etc. easily from the reaction product. The reaction time depends on the raw material to be used, the type and the amount of the catalyst, and the reaction temperature and the like, but is preferably up to the time when the reaction of the raw material A and the raw material B is substantially completed, that is the time when the carboxylic acid, the alcohol, and water are not produced. The reaction time is preferably 30 minutes to 24 hours, more preferably 1 to 12 hours.

The reaction method in the production of the above-mentioned polyhydric phenol compound may be carried out in the presence of a solvent. The solvent preferably includes an organic solvent inactive to the reaction of the raw material A and the raw material B. Examples of the solvent are toluene, xylene, monochlorobenzene, and dichlorobenzene. Use of the solvent enables to dissolve the raw material therein and provides the homogeneity. In the case of reacting the raw material B1, the reaction is preferably carried out in solvent-free state.

In the production method of the above-mentioned polyhydric phenol compound, in the case of removing the carboxylic acid, the alcohol, and water, etc. produced as byproducts and the solvent, it is preferable to remove them by distillation at the above-mentioned temperature under the reduced pressure of 0.1 to 10 kPa. In this case, since the residual phenols may possibly be removed by distillation, the removal is preferably carried out after the reaction is substantially completed.

### (1-2) The Compound Having a Polymerizable Unsaturated Bond

The compound having the polymerizable unsaturated bond is not limited as long as the compound has a polymerizable unsaturated bond, and includes a compound having at least one group selected from a group consisting of an (meth)acryloyl group, a vinyl group, a fumarate group, and a maleimide group. That is, the compound is preferably at least one compound selected from a group consisting of a compound having (meth)acryloyl group, a compound having a vinyl group, a compound having a fumarate group, and a compound having a maleimide group. In the present invention, the (meth)acryloyl group mean an acryloyl group and a methacryloyl group, and in the case of the compound having an acryloyl group, a vinyl group exists in the acryloyl group, however in such a case, the compound is not regarded to have both an acryloyl group and a vinyl group but is regarded to have an acryloyl group. The fumarate group is regarded as a group having fumarate structure, that is, the group having fumaric acid ester structure.

Examples of the above-mentioned compound having the (meth)acryloyl group are a (poly)ester (meth)acrylate, an urethane (meth)acrylate, an epoxy (meth)acrylate, a (poly)ether (meth)acrylate, an alkyl (meth)acrylate, an alkylene (meth)acrylate, a (meth)acrylate having an aromatic ring, and a (meth)acrylate having an alicyclic structure. The above compounds may be used alone or in combination of two or more of them.

The above-mentioned (poly)ester (meth)acrylate is a (meth)acrylate having one or more ester bond in the main chain. Examples of the preferable (poly)ester (meth)acrylates are a monofunctional (poly)ester (meth)acrylate such as alicyclic-modified neopentyl glycol (meth)acrylate (R-629 or R-644, manufactured by Nippon Kayaku Co., Ltd.), caprolactone-modified 2-hydroxyethyl (meth)acrylate, ethylene oxide and/or propylene oxide-modified phthalic acid (meth)acrylate, ethylene oxide-modified succinic acid (meth)acrylate, and caprolactone-modified tetrahydrofurfuryl (meth)acrylate; pivalic acid ester neopentyl glycol di(meth)acrylate, caprolactone-modified hydroxypivalic acid ester neopentyl glycol di(meth)acrylate, epichlorohydrin-modified phthalic acid di(meth)acrylate; mono-, di-, or tri-(meth)acrylate of the triol obtained by adding 1 mole or more of cyclic lactone compound such as ε-caprolactone, γ-butyrolactone, δ-valerolactone or methylvalerolactone to 1 mole of trimethylolpropane or glycerin; mono-, di-, tri- or tetra(meth)acrylate of the triol obtained by adding 1 mole or more of cyclic lactone compound such as ε-caprolactone, γ-butyrolactone, δ-valerolactone or methylvalerolactone to 1 mole of pentaerythritol or ditrimethylolpropane; mono-(meth)acrylate or poly(meth)acrylate of polyhydric alcohol such as triols, tetraols, pentaols or hexaols of mono or poly(meth)acrylates of triols obtained by adding 1 mole or more of cyclic lactone compound such as ε-caprolactone, γ-butyrolactone, δ-valerolactone or methylvalerolactone to 1 mole of dipentaerythritol; and (meth)acrylate of an polyester polyol comprising a diols component such as (poly)ethylene glycol, (poly)propylene glycol, (poly)tetramethylene glycol, (poly)butylene glycol, (poly)pentadiol, (poly)methylpentanediol, and (poly)hexanediol and a polybasic acid such as maleic acid, fumaric acid, succinic acid, adipic acid, phthalic acid, hexahydrophthalic acid, tetrahydrophthalic acid, itaconic acid, citraconic acid, Het acid, himic acid, chlorendic acid, dimer acid, alkenylsuccinic acid, sebacic acid, azelaic acid, 2,2,4-trimethyladipic acid, 1,4-cyclohexanedicarboxylic acid, terephthalic acid, sodium 2-sulfoterephthalic acid, potassium 2-sulfoterephthalic acid, isophthalic acid, sodium 5-sulfoisophthalic acid, potassium 5-sulfoisophthalic acid, orthophthalic acid, 4-sulfophthalic acid, 1,10-decamethylenedicarboxylic acid, muconic acid, oxalic acid, malonic acid, glutaric acid, trimellitic acid, pyromellitic acid; a polyfunctional (poly)ester (meth)acrylate such as (meth)acrylate of cyclic lactone-modified polyester diol comprising the above-exemplified diol component and a polybasic acid and ε-caprolactone, γ-butyrolactone, δ-valerolactone or methylvalerolactone.

The above-mentioned urethane (meth)acrylate is a (meth)acrylate having one or more urethane bond in the main chain and is preferably a compound obtained by reaction of a hydroxy compound having at least one (meth)acryloyloxy group and an isocyanate compound.

Examples of the preferable hydroxy compounds having at least one (meth)acryloyloxy group are various kinds of (meth)acrylate compounds having a hydroxyl group such as 2-hydroxyethyl (meth)acrylate, 2-hydroxypropyl(meth)acrylate, 2-hydroxybutyl (meth)acrylate, 3-hydroxybutyl (meth)acrylate, 4-hydroxybutyl (meth)acrylate, cyclohexanedimethanol (meth)acrylate, polyethylene glycol mono(meth)acrylate, polypropylene glycol mono(meth)acrylate, trimethylolpropane di(meth)acrylate, trimethylolethane di(meth)acrylate, pentaerythritol tri(meth)acrylate, glycidyl (meth)acrylate-(meth)acrylic acid adducts, and 2-hydroxy-3-phenoxypropyl (meth)acrylate; and a ring opening reaction product and the like of the above exemplified (meth)acrylate compound having a hydroxyl group and ε-caprolactone.

Examples of the preferable isocyanate compounds are an aromatic diisocyanate compound such as p-phenylene diisocyanate, m-phenylene diisocyanate, p-xylene diisocyanate, m-xylene diisocyanate, 2,4-tolylene diisocyanate, 2,6-tolylene diisocyanate, 4,4′-diphenylmethane diisocyanate, 3,3′-dimethyldiphenyl-4,4′-diisocyanate, 3,3′-diethyldiphenyl-4,4′-diisocyanate, naphthalene diisocyanate; an aliphatic or alicyclic diisocyanate such as isophorone diisocyanate, hexamethylene diisocyanate, 4,4′-dicyclohexylmethane diisocyanate, hydrogenated xylene diisocyanate, norbornene diisocyanate, and lysine diisocyanate; a polyisocyanate such as buret type of one or more isocyanate monomers and an isocyanurate of trimers of the above exemplified diisocyanate compound; and a polyisocyanate obtained by urethanization of these isocyanate compound and various kinds of polyols.

Examples of the polyols as the raw materials for preparing the above-mentioned polyisocyanate are an alkylene glycol such as (poly)ethylene glycol, (poly)propylene glycol, (poly)butylene glycol, and (poly)tetramethylene glycol; an ethylene oxide-modified product, a propylene oxide-modified product, a butylene oxide-modified product, a tetrahydrofuran-modified product, an ε-caprolactone-modified product, a γ-butyrolactone-modified product, an δ-valerolactone-modified product, and a methylvalerolactone-modified product of an alkylene glycol such as ethylene glycol, propanediol, propylene glycol, tetramethylene glycol, pentamethylene glycol, hexanediol, neopentyl glycol, glycerin, trimethylolpropane, pentaerythritol, diglycerin, ditrimethylolpropane, and dipentaerythritol; a hydrocarbon type polyol such as an ethylene oxide-propylene oxide copolymer, a propylene glycol-tetrahydrofuran copolymers, an ethylene glycol-tetrahydrofuran copolymer; polyisoprene glycol, a hydrogenated polyisoprene glycol, a polybutadiene glycol, and a hydrogenated polybutadiene glycol; an aliphatic polyester polyol which is an esterification reaction product of an aliphatic dicarboxylic acid such as adipic acid and dimer acid and a polyol such as neopentyl glycol and methylpentanediol; an aromatic polyester polyol which is an esterification reaction product of an aromatic dicarboxylic acid such as terephthalic acid and a polyol such as neopentyl glycol;

a polycarbonate polyol; an acrylic polyol; a polyhydric hydroxyl group compound such as polytetramethylene hexaglyceryl ether (tetrahydrofuran-modified compound of hexaglycerin); a mono- and polyhydric hydroxyl group-containing compound of the above-mentioned polyhydric hydroxyl group-containing compounds having an ether group at the terminal thereof; a polyhydric hydroxyl group-containing compound obtained by esterification of the above-mentioned polyhydric hydroxyl group-containing compound with a dicarboxylic acid such as fumaric acid, phthalic acid, isophthalic acid, itaconic acid, adipic acid, sebacic acid, and maleic acid; and a polyhydric hydroxyl group-containing compound such as a monoglyceride obtained by ester interchange reaction of a polyhydric hydroxyl group compound such as glycerin and a fatty acid esters of animals and plants.

The above-mentioned epoxy (meth)acrylate is a (meth)acrylate obtained by reaction of mono- or higher functional epoxide and (meth)acrylic acid. Examples of the epoxide are an epichlorohydrin-modified hydrogenated bisphenol type epoxy resin synthesized by reaction of (methyl)epichlorohydrin with hydrogenated bisphenol A, hydrogenated bisphenol S, hydrogenated bisphenol F, and ethylene oxide-modified and propylene oxide-modified compound thereof; an alicyclic epoxy resin such as 3,4-epoxycyclohexylmethyl-3,4-epoxycyclohexanecarboxylate and bis-(3,4-epoxycyclohexyl)adipate; an alicyclic epoxide of a hetero ring-containing epoxy resin and the like such as triglycidyl isocyanurate; an epichlorohydrin-modified bisphenol type epoxy resin synthesized by reaction of (methyl)epichlorohydrin with bisphenol A, bisphenol S, bisphenol F, and ethylene oxide-modified and propylene oxide-modified compound thereof and the like; a phenol novolak type epoxy resin; a cresol novolak type epoxy resin; a epoxylated compound of a various dicyclopentadiene-modified phenol resin obtained by reaction of dicyclopentadiene and various kinds of phenols; an epoxylated compound of 2,2′,6,6′-tetramethylbiphenol; an aromatic epoxide of phenyl glycidyl ether; a (poly)glycidyl ether of a glycol such as (poly)ethylene glycol, (poly)propylene glycol, (poly)butylene glycol, (poly)tetramethylene glycol, and neopentyl glycol; a (poly)glycidyl ether of alkylene oxide modified glycol; a (poly)glycidyl ether of an aliphatic polyhydric alcohol such as trimethylolpropane, trimethylolethane, glycerin, diglycerin, erythritol, pentaerythritol, sorbitol, 1,4-butanediol, and 1,6-hexanediol; an alkylene type epoxide such as a (poly)glycidyl ether of alkylene oxide modified product of an aliphatic polyhydric alcohol; a glycidyl ester of the carboxylic acid such as adipic acid, sebacic acid, maleic acid, and itaconic acid and a glycidyl ether of a polyester polyol comprising a polyhydric alcohol and a polycarboxylic acid; a copolymer of glycidyl (meth)acrylate and methylglycidyl (meth)acrylate; and an aliphatic epoxy resin and the like such as a glycidyl ester of a higher fatty acid, an epoxylated linseed oil, an epoxylated soybean oil, an epoxylated ricinus oil, and an epoxylated polybutadiene.

The above-mentioned (poly)ether (meth)acrylate is a (meth)acrylate having one or more ether bond in the main chain. Examples of the preferable (poly)ether (meth)acrylate are a mono-functional (poly)ether (meth)acrylate such as butoxyethyl (meth)acrylate, butoxytriethylene glycol (meth)acrylate, epichlorohydrin-modified butyl (meth)acrylate, dicyclopentenyloxyethyl (meth)acrylate, 2-ethoxyethyl (meth)acrylate, ethylcarbitol (meth)acrylate, 2-methoxy(poly)ethylene glycol (meth)acrylate, methoxy(poly)propylene glycol (meth)acrylate, nonylphenoxy polyethylene glycol (meth)acrylate, nonylphenoxypolypropylene glycol (meth)acrylate, phenoxyhydroxypropyl (meth)acrylate, phenoxy(poly)ethylene glycol (meth)acrylate, polyethylene glycol mono(meth)acrylate, polypropylene glycol mono(meth)acrylate, and polyethylene glycol/polypropylene glycol mono(meth)acrylate; an alkylene glycol di(meth)acrylate such as polyethylene glycol di(meth)acrylate, polypropylene glycol di(meth)acrylate, polybutylene glycol di(meth)acrylate, and polytetramethylene glycol di(meth)acrylate; a polyfunctional (meth)acrylate derived from (meth)acrylic acid and a hydrocarbon type polyol such as ethylene oxide-propylene oxide copolymer, a propylene glycol-tetrahydrofuran copolymer, an ethylene glycol-tetrahydrofuran copolymer, a polyisoprene glycol, a hydrogenated polyisoprene glycol, a polybutadiene glycol, and a hydrogenated polybutadiene glycol, a polyhydric hydroxyl group compound such as polytetramethylene hexaglyceryl ether (tetrahydrofuran-modified compound of hexaglycerin); a di(meth)acrylate of a diol obtained by adding 1 mole or more of a cyclic ether such as ethylene oxide, propylene oxide, butylene oxide and/or tetrahydrofuran to 1 mole of neopentyl glycol; a di(meth)acrylate of an alkylene oxide-modified product of bisphenol such as bisphenol A, bisphenol F, and bisphenol S; a di(meth)acrylate of an alkylene oxide-modified product of hydrogenated bisphenols such as hydrogenated bisphenol A, hydrogenated bisphenol F, and hydrogenated bisphenol S; a di(meth)acrylate of alkylene oxide-modified product of trisphenols; a di(meth)acrylate of alkylene oxide-modified product of hydrogenated trisphenols; a di(meth)acrylate of alkylene oxide-modified product of p,p′-biphenols; an di(meth)acrylate of alkylene oxide-modified product of hydrogenated p,p′-biphenols; a di(meth)acrylate of alkylene oxide-modified product of p,p′-dihydroxybenzophenones; a mono-, di-, or tri-(meth)acrylate of a triol obtained by adding 1 mole or more of a cyclic ether compound such as ethylene oxide, propylene oxide, butylene oxide and/or tetrahydrofuran to 1 mole of trimethylolpropane or glycerin; a mono-, di-, or tri-(meth)acrylates of a trio obtained by adding 1 mole or more of a cyclic ether compound such as ethylene oxide, propylene oxide, butylene oxide and/or tetrahydrofuran to 1 mole of pentaerythritol or ditrimethylolpropane; and a mono-functional (poly)ether (meth)acrylate or a poly-functional (poly)ether (meth)acrylate of a polyhydric alcohol such as a triol, a tetraol, a pentaol, a hexaol such as a mono or poly(meth)acrylate of a triol obtained by adding 1 mole or more of a cyclic ether compound such as ethylene oxide, propylene oxide, butylene oxide and/or tetrahydrofuran to 1 mole of dipentaerythritol.

The alkyl (meth)acrylate or alkylene (meth)acrylate has normal alkyl, branched alkyl, normal alkylene group or branched alkylene group as a main chain and optionally may include halogen atom and/or a hydroxyl group in the side chain or at the terminal. Examples of the preferable alkyl (meth)acrylates are a mono-functional (meth)acrylate such as methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, decyl (meth)acrylate, dodecyl (meth)acrylate, tridecyl (meth)acrylate, pentadecyl (meth)acrylate, myristyl (meth)acrylate, palmityl (meth)acrylate, stearyl (meth)acrylate, neryl (meth)acrylate, geranyl (meth)acrylate, farnesyl (meth)acrylate, hexadecyl (meth)acrylate, octadecyl (meth)acrylate, docosyl (meth)acrylate, and trans-2-hexene (meth)acrylate; a di(meth)acrylate of hydrocarbon diol such as ethylene glycol di(meth)acrylate, propylene glycol di(meth)acrylate, 1,2-butylene glycol di(meth)acrylate, 1,3-butylene glycol di(meth)acrylate, 1,4-butanediol di(meth)acrylate, 1,6-hexanediol di(meth)acrylate, neopentyl glycol di(meth)acrylate, 2-methyl-1,8-octanediol di(meth)acrylate, 1,9-nonanediol di(meth)acrylate, and 1,10-decanediol di(meth)acrylate; a mono(meth)acrylate or a poly(meth)acrylate of a polyhydric alcohol such as mono(meth)acrylate, di(meth)acrylate, or tri(meth)acrylate of trimethylolpropane (hereinafter, “poly” will be used as generalized name of di-, tri-, or tetra-polyfunction), a mono(meth)acrylate or poly(meth)acrylate of glycerin, a mono(meth)acrylate or a poly(meth)acrylate of pentaerythritol, a mono(meth)acrylate or a poly(meth)acrylate of ditrimethylolpropane, and a mono(meth)acrylate or a poly(meth)acrylate of dipentaerythritol; a hydroxyl group-containing (meth)acrylate such as 2-hydroxyethyl (meth)acrylate, 2-hydroxypropyl (meth)acrylate, 4′-hydroxybutyl (meth)acrylate, and 3-chloro-2-hydroxyethyl (meth)acrylate; a (meth)acrylate having a bromine atom such as 2,3-dibromopropyl (meth)acrylate, tribromophenyl (meth)acrylate, ethylene oxide-modified tribromopheny (meth)acrylate and ethylene oxide-modified tetrabromobisphenol A di(meth)acrylate; a (meth)acrylate having a fluorine atom such as trifluoroethyl (meth)acrylate, pentafluoropropyl (meth)acrylate, tetrafluoropropyl (meth)acrylate, octafluoropentyl (meth)acrylate, dodecafluoroheptyl (meth)acrylate, hexadecafluorononyl (meth)acrylate, hexafluorobutyl (meth)acrylate, 3-perfluorobutyl-2-hydroxypropyl (meth)acrylate, 3-perfluorohexyl-2-hydroxypropyl (meth)acrylate, 3-perfluorooctyl-2-hydroxypropyl (meth)acrylate, 3-(perfluoro-5-methylhexyl)-2-hydroxypropyl (meth)acrylate, 3-(perfluoro-7-methyloctyl)-2-hydroxypropyl (meth)acrylate, and 3-(perfluoro-8-methyldecyl)-2-hydroxypropyl (meth)acrylate.

The (meth)acrylates having the aromatic ring is a (meth)acrylate having an aromatic ring in the main chain or in the side chain. Examples of the preferable (meth)acrylate are a monofunctional (meth)acrylate such as phenyl (meth)acrylate and benzyl acrylate; and a diacrylate such as bisphenol A diacrylate, bisphenol F diacrylate, and bisphenol S diacrylate.

The (meth)acrylate having the alicyclic structure is a (meth)acrylate having an alicyclic structure which may contain oxygen atom or nitrogen atom in the constituent unit in the main chain or in the side chain. Examples of the preferable (meth)acrylate are the mono-functional (meth)acrylate having the alicyclic structure such as cyclohexyl (meth)acrylate, cyclopentyl (meth)acrylate, cycloheptyl (meth)acrylate, bicycloheptyl (meth)acrylate, isobornyl (meth)acrylate, bicyclopentyl di(meth)acrylate, tricyclodecyl (meth)acrylate, bicyclopentenyl (meth)acrylate, norbornyl (meth)acrylate, bicyclooctyl (meth)acrylate, tricycloroheptyl (meth)acrylate, and cholesteroid backbone-substituted (meth)acrylate; a di(meth)acrylate such as a di(meth)acrylate of hydrogenated bisphenol such as hydrogenated bisphenol A, hydrogenated bisphenol F, and hydrogenated bisphenol S, a di(meth)acrylate of hydrogenated trisphenol, and a di(meth)acrylates of hydrogenated p,p′-biphenol; a polyfunctional (meth)acrylate having a cyclic structure such as dicyclopentane type di(meth)acrylate such as Kayarad R 684 (manufactured by Nippon Kayaku Co., Ltd.), tricyclodecanedimethylol of di(meth)acrylate, and bisphenolfluorene dihydroxy(meth)acrylate; and an alicyclic acrylate having an oxygen atom and/or a nitrogen atom in the structure such as tetrahydrofurfuryl (meth)acrylate and morpholinoethyl (meth)acrylate.

Examples of the above-mentioned compound having a (meth)acryloyl group are a poly(meth)acryl (meth)acrylate such as a reaction product of a (meth)acrylic acid polymer and glycidyl (meth)acrylate, and a reaction product of a glycidyl (meth)acrylate polymer and (meth)acrylic acid; an amino group-containing (meth)acrylate such as dimethylaminoethyl (meth)acrylate; an isocyanuric (meth)acrylate such as tris((meth)acryloxyethyl) isocyanurate; a phosphazene (meth)acrylate such as hexakis[((meth)acryloyloxyethyl)cyclotriphosphazene]; a (meth)acrylate having polysiloxane backbone; a polybutadiene (meth)acrylate; and melamine (meth)acrylate. Among these compounds having the (meth)acryloyl group, the compound having 1 to 6 (meth)acryloyl groups in a molecule thereof are preferable.

Examples of the above-mentioned vinyl group-containing compound are alkyl vinyl ether where the halogen atom, hydroxyl group, or amino group may substitute for another terminal (hereinafter, referred to as alkyl vinyl ether), a cycloalkyl vinyl ether where the halogen atom, hydroxyl group, or amino group may substitute for another terminal (hereinafter, referred to as cycloalkyl vinyl ether), a monovinyl ether, a divinyl ether, and a polyvinyl ether having a structure in which one or more groups selected from a group consisting of an alkyl group where vinyl ether group is bonded to an alkylene group, and optionally substituted with a substituent group, a cycloalkyl group, and an aromatic group are be bonded through one or more bonds selected from a group consisting of ether bond, urethane bond, and ester bond thereinafter, they may sometimes be referred as to monovinyl ethers, divinyl ethers, and polyvinyl ethers). The above compounds can be used alone or in combination of at least two of them.

Examples of the above-mentioned alkyl vinyl ether are methyl vinyl ether, hydroxymethyl vinyl ether, chloromethyl vinyl ether, ethyl vinyl ether, 2-hydroxyethyl vinyl ether, 2-chloroethyl vinyl ether, diethylaminoethyl vinyl ether, propyl vinyl ether, 3-hydroxypropyl vinyl ether, 2-hydroxypropyl vinyl ether, 3-chloropropyl vinyl ether, 3-aminopropyl vinyl ether, isopropyl vinyl ether, butyl vinyl ether, 4-hydroxybutyl vinyl ether, isobutyl vinyl ether, 4-aminobutyl vinyl ether, pentyl vinyl ether, isopentyl vinyl ether, hexyl vinyl ether, 1,6-hexanediol mono-vinyl ether, heptyl vinyl ether, 2-ethylhexyl vinyl ether, octyl vinyl ether, isooctyl vinyl ether, nonyl vinyl ether, isononyl vinyl ether, decyl vinyl ether, isodecyl vinyl ether, dodecyl vinyl ether, isododecyl vinyl ether, tridecyl vinyl ether, isotridecyl vinyl ether, pentadecyl vinyl ether, isopentadecyl vinyl ether, hexadecyl vinyl ether, octadecyl vinyl ether, methylene glycol divinyl ether, ethylene glycol divinyl ether, propylene glycol divinyl ether, 1,4-butanediol divinyl ether, 1,6-hexane diol divinyl ether, cyclohexanediol divinyl ether, trimethylolpropane trivinyl ether, and pentaerythritol tetravinyl ether.

Examples of the preferable cycloalkyl vinyl ether are cyclopropyl vinyl ether, 2-hydroxycyclopropyl vinyl ether, 2-chlorocyclopropyl vinyl ether, cyclopropylmethyl vinyl ether, cyclobutyl vinyl ether, 3-hydroxycyclobutyl vinyl ether, 3-chlorocyclobutyl vinyl ether, cyclobutylmethyl vinyl ether, cyclopentyl vinyl ether, 3-hydroxycyclopentyl vinyl ether, 3-chlorocyclopentyl vinyl ether, cyclopentylmethyl vinyl ether, cyclohexyl vinyl ether, 4-hydroxycyclohexyl vinyl ether, cyclohexylmethyl vinyl ether, 4-aminocyclohexyl vinyl ether, cyclohexanediol monovinyl ether, cyclohexanedimethanol monovinyl ether, and cyclohexanedimethanol divinyl ether.

Preferable examples of the above-mentioned compounds having the ether bond among the monovinyl ether, divinyl ether, and polyvinyl ether are ethylene glycol methyl vinyl ether, diethylene glycol monovinyl ether, diethylene glycol methyl vinyl ether, diethylene glycol divinyl ether, triethylene glycol monovinyl ether, triethylene glycol methyl vinyl ether, triethylene glycol divinyl ether, polyethylene glycol monovinyl ether, polyethylene glycol methyl vinyl ether, polyethylene glycol divinyl ether, propylene glycol methyl vinyl ether, dipropylene glycol monovinyl ether, dipropylene glycol methyl vinyl ether, dipropylene glycol divinyl ether, tripropylene glycol monovinyl ether, tripropylene glycol methyl vinyl ether, tripropylene glycol divinyl ether, polypropylene glycol monovinyl ether, polypropylene glycol methyl vinyl ether, polypropylene glycol divinyl ether, tetramethylene glycol methyl vinyl ether, di(tetramethylene glycol) monovinyl ether, di(tetramethylene glycol) methyl vinyl ether, di(tetramethylene glycol) divinyl ether, tri(tetramethylene glycol) monovinyl ether, tri(tetramethylene glycol) methyl vinyl ether, tri(tetramethylene glycol) divinyl ether, poly(tetramethylene glycol) monovinyl ether, poly(tetramethylene glycol) methyl vinyl ether, poly(tetramethylene glycol) divinyl ether, 1,6-hexanediol methyl vinyl ether, di(hexamethylene glycol) monovinyl ether, di(hexamethylene glycol) methyl vinyl ether, di(hexamethylene glycol) divinyl ether, tri(hexamethylene glycol) monovinyl ether, tri(hexamethylene glycol) methyl vinyl ether, tri(hexamethylene glycol) divinyl ether, poly(hexamethylene glycol) monovinyl ether, poly(hexamethylene glycol) methyl vinyl ether, and poly(hexamethylene glycol) divinyl ether.

The compound having the urethane bond among the monovinyl ether, divinyl ether, and polyvinyl ethers preferably includes a compound obtained by urethanization reaction of monovinyl ether of (poly)alkylene glycol having at least one hydroxyl group in one molecule with a compound having at least one isocyanate group in one molecule.

Examples of the above-mentioned monovinyl ether of (poly)alkylene glycol having at least one hydroxyl group in one molecule are 2-hydroxyethyl vinyl ether, diethylene glycol monovinyl ether, polyethylene glycol monovinyl ether, 3-hydroxypropyl vinyl ether, 2-hydroxy-2-methylethyl vinyl ether, dipropylene glycol monovinyl ether, polypropylene glycol monovinyl ether, 4-hydroxybutyl vinyl ether, and 1,6-hexanediol monovinyl ether.

Preferable examples of the above-mentioned compounds having at least one isocyanate group in one molecule are an aromatic isocyanate such as m-isopropenyl-α,α-dimethylbenzyl isocyanate, p-phenylene diisocyanate, m-phenylene diisocyanate, p-xylene diisocyanate, m-xylene diisocyanate, 2,4-tolylene diisocyanate, 2,6-tolylene diisocyanate, 4,4′-diphenylmethane diisocyanate, 3,3′-dimethyldiphenyl-4,4′-diisocyanate, 3,3′-diethyldiphenyl-4,4′-diisocyanate, and naphthalene diisocyanate; an aliphatic and alicyclic isocyanate such as propyl isocyanate, isophorone diisocyanate, hexamethylene diisocyanate, 4,4′-dicyclohexylmethane diisocyanate, hydrogenated xylene diisocyanate, norbornene diisocyanate, and lysine diisocyanate. Also, a polyisocyanate such as a dimer or a trimer of one or more of the above-mentioned compound having at least one isocyanate group in one molecule may be used as a raw material of the compound having the urethane bond.

As the compound having the urethane bond among the above-mentioned monovinyl ether, divinyl ether, and polyvinyl ether, optionally used is an adduct obtained by urethanization reaction of a compound having two or more isocyanate groups in one molecule among the above-mentioned compound having at least one isocyanate group in one molecule and various kinds of alcohols.

The above-mentioned alcohol preferably includes a compound having at least one hydroxyl group in one molecule and a compound having an average molecular weight of 100,000 or less. Examples of the preferable alcohols are methanol, ethanol, propanol, isopropanol, butanol, isobutanol, ethylene glycol, 1,3-propylene glycol, 1,2-propylene glycol, diethylene glycol, dipropylene glycol, neopentyl glycol, 1,3-butane diol, 1,4-butanediol, 1,6-hexanediol, 1,9-nonanediol, 1,10-decanediol, 2,2,4-trimethyl-1,3-pentanediol, 3-methyl-1,5-pentanediol, dichloroneopentyl glycol, dibromoneopentyl glycol, hydroxypivalic acid neopentyl glycol ester, cyclohexanedimethylol, 1,4-cyclohexanediol, spiroglycol, tricyclodecanedimethylol, hydrogenated bisphenol A, ethylene oxide-added bisphenol A, propylene oxide-added bisphenol A, dimethylolpropionic acid, dimethylolbutanoic acid, trimethylolethane, trimethylolpropane, glycerin, 3-methylpentane-1,3,5-triol, tris(2-hydroxyethyl) isocyanurate. These compounds may be used alone or in combination of two or more of them.

As the above-mentioned alcohol, a polyester polyol, a polyether polyol, and a polycarbonate polyol may be used. The polyester polyol includes one obtained by reacting a polyol among the above-mentioned alcohols and a carboxylic acid. As the above-mentioned carboxylic acid, well known various kinds of carboxylic acids and the anhydrides thereof can be used. Examples of the preferable carboxylic acids and the anhydrides thereof are maleic acid, fumaric acid, itaconic acid, citraconic acid, tetrahydrophthalic acid, Het acid, himic acid, chlorendic acid, dimer acid, adipic acid, succinic acid, alkenylsuccinic acid, sebacic acid, azelaic acid, 2,2,4-trimethyladipic acid, 1,4-cyclohexanedicarboxylic acid, terephthalic acid, sodium 2-sulfoterephthalate, potassium 2-sulfoterephthalate, isophthalic acid, sodium 5-sulfoisophthalate, potassium 5-sulfoisophthalate, sodium-5-sulfoisophthalic acid di-lower alkyl esters such as sodium-5-sulfoisophthalate dimethyl or diethyl esters, orthophthalic acid, 4-sulfophthalic acid, 1,10-decamethylenedicarboxylic acid, muconic acid, oxalic acid, malonic acid, glutaric acid, trimellitic acid, hexahydrophthalic acid, tetrabromophthalic acid, methylcyclohexenetricarboxylic acid, and pyromellitic acid and the anhydrides thereof and the ester compound with an alcohol such as methanol and ethanol. Further, a lactone polyol obtained by the ring-opening reaction of ε-caprolactone with the above-mentioned polyol component may be used.

As the above-mentioned polyether polyol, a well known polyether polyol can be used. Examples of the preferable polyether polyol are an ether glycol such as polytetramethylene glycol, propylene oxide-modified polytetramethylene glycol, ethylene oxide-modified polytetramethylene glycol, polypropylene glycol, and polyethylene glycol and a polyether polyol obtained by ring-opening polymerization of the cyclic ether using tri- or higher functional polyol as an initiator.

The above-mentioned polycarbonate polyol preferably includes one obtained by ester interchange reaction of carbonate and various kinds of polyols. Examples of the preferable carbonates are diaryl carbonates and dialkyl carbonates such as diphenyl carbonate, bischlorophenyl carbonate, dinaphthyl carbonate, phenyl-tolyl carbonate, phenyl-chlorophenyl carbonate, and 2-tolyl-4-tolyl carbonate, and dimethyl carbonate and diethyl carbonate. The polyol as a raw material for producing the above-mentioned polycarbonate polyol preferably includes the above-mentioned alcohol, polyester polyol, and polyether polyol.

The compound having an ester bond among the above-mentioned monovinyl ether, divinyl ether, and polyvinyl ether preferably includes one obtained by esterification reaction of monovinyl ether of alkylene glycol having at least one hydroxyl group in one molecule and a compound having at least one carboxyl group in one molecule.

The above-mentioned monovinyl ether of alkylene glycol having at least one hydroxyl group in one molecule preferably includes a monovinyl ether of (poly)alkylene glycol having at least one hydroxyl group in one molecule among the above-mentioned compounds having the urethane bonds.

As the above-mentioned compound having at least one carboxyl group in one molecule, a well known carboxylic acid and the anhydride can be used. Examples of the preferable carboxylic acid are formic acid, acetic acid, propionic acid, valeric acid, benzoic acid, maleic acid, fumaric acid, itaconic acid, citraconic acid, tetrahydrophthalic acid, Het acid, himic acid, chlorendic acid, dimer acid, adipic acid, succinic acid, alkenylsuccinic acid, sebacic acid, azelaic acid, 2,2,4-trimethyladipic acid, 1,4-cyclohexanedicarboxylic acid, terephthalic acid, sodium 2-sulfoterephthalate, potassium 2-sulfoterephthalate, isophthalic acid, sodium 5-sulfoisophthalate, potassium 5-sulfoisophthalate; sodium-5-sulfoisophthalic acid di-lower alkyl esters such as sodium-5-sulfoisophthalate dimethyl or diethyl esters, orthophthalic acid, 4-sulfophthalic acid, 1,10-decamethylenedicarboxylic acid, muconic acid, oxalic acid, malonic acid, glutaric acid, trimellitic acid, hexahydrophthalic acid, tetrabromophthalic acid, methylcyclohexenetricarboxylic acid, and pyromellitic acid and their anhydrides. Further, the carboxylic acid obtained by reaction of a compound having two or more carboxyl groups in one molecule among those carboxylic acids and an alcohol in the above-mentioned compounds having a urethane bond can be used.

The above-mentioned compound having a fumarate group preferably includes a fumaric acid ester such as dimethyl fumarate and diethyl fumarate and an esterification reaction product of fumaric acid and polyhydric alcohol. These compound can be used alone or in combination of two or more of them.

Examples of the above-mentioned compounds having a maleimide group are a mono-functional aliphatic maleimide such as N-methylmaleimide, N-ethylmaleimide, N-propylmaleimide, N-n-butylmaleimide, N-tert-butylmaleimide, N-pentylmaleimide, N-hexylmaleimide, N-laurylmaleimide, 2-maleimidoethyl-ethyl carbonate, 2-maleimidoethyl-isopropyl carbonate, and N-ethyl-(2-maleimidoethyl) carbamate; an alicyclic mono-functional maleimide such as N-cyclohexylmaleimide; aromatic mono-functional maleimides such as N-phenylmaleimide, N-2-methylphenylmaleimide, N-2-ethylphenylmaleimide, N-(2,6-diethylphenyl)maleimide, N-2-chlorophenylmaleimide, N-(4-hydroxylphenyl)maleimide, and N-2-trifluoromethylphenylmaleimide; an alicyclic bismaleimide such as N,N′-methylenebismaleimide, N,N′-ethylenebismaleimide, N,N′-trimethylenebismaleimide, N,N′-hexamethylenebismaleimide N,N′-dodecamethylenebismaleimide, and 1,4-dimaleimidocyclohexane; and an aromatic bismaleimide such as N,N′-(4,4′-diphenylmethane)bismaleimide, N,N′-(4,4′-diphenyloxy)bismaleimide, N,N′-p-phenylenebismaleimide, N,N′-m-phenylenebismaleimide, N,N′-2,4-tolylenebismaleimide, N,N′-2,6-tolylenebismaleimide, N,N′-[4,4′-bis(3,5-dimethylphenyl)methane]bismaleimide, and N,N′-[4,4′-bis(3,5-diethylphenyl)methane]bismaleimide. These compounds can be used alone or in combination of two or more of them.

Examples of other compounds to be used as the compounds having polymerizable unsaturated bonds of the present invention are a mono-functional (meth)acrylamide such as N-isopropyl (meth)acrylamide; a poly-functional (meth)acrylamide such as methylene bis(meth)acrylamide; a carboxylic acid vinyl derivative such as vinyl acetate, vinyl cinnamate; a styrene derivative such as styrene and divinylstyrene; an acrylate such as lauryl acrylate, isodecyl acrylate, isostearyl acrylate, lauryl alcohol ethoxyacrylate, epoxystearyl acrylate, 2-(1-methyl-4-dimethyl)butyl-5-methyl-7-dimethyloctyl acrylate, phenoxyethyl acrylate, phenoxyethoxyethyl acrylate, phenol polyalkoxyacrylate, nonyl phenoxyethyl acrylate, nonylphenol ethylene oxide-modified acrylate, nonylphenol propylene oxide-modified acrylate, butoxy polypropylene glycol acrylate, tetrahydrofurfuryl alcohol lactone-modified acrylate, lactone-modified 2-hydroxyethyl acrylate, 2-ethylhexylcarbitol acrylate, 2-hydroxy-3-phenoxypropyl acrylate, acrylic acid dimer, ω-carboxy-polycaprolactone monoacrylate, tetrahydrofurfuryl acrylate, hydroxyethyl acrylate, hydroxypropyl acrylate, hydroxybutyl acrylate, isobornyl acrylate, dicyclopentenyloxyalkyl acrylate, dicyclopentenyl acrylate, tricyclodecanyl acrylate, tricyclodecanyloxyethyl acrylate, and isobornyloxyethyl acrylate; an acrylamide such as acryloylmorpholine and diacetone acrylamide; a N-vinylamide such as N-vinylpyrrolidone and N-vinylcaprolactam; a vinyl ether such as hydroxybutyl vinyl ether and lauryl vinyl ether; a maleimide such as chlorophenylmaleimide, cyclohexylmaleimide, and laurylmaleimide; and ethylene glycol di(meth)acrylate, triethylene glycol diacrylate, propylene glycol diacrylate, tripropylene glycol diacrylate, diacrylate of hydroxypivalic acid neopentyl glycol, diacrylate of ethylene oxide-added bisphenol A, diacrylate of propyleneoxide-added bisphenol A, tricyclodecanedimethylol diacrylate, acryl acid-added 2,2-di(glycidyloxyphenyl)propane, trimethylolpropane triacrylate, pentaerythritol triacrylate, pentaerythritol tetraacrylate, dipentaerythritol hexaacrylate, triacrylate of tris(2-hydroxyethyl)isocyanurate, diacrylate of tris(2-hydroxyethyl)isocyanurate, triacrylate of tris(hydroxypropyl)isocyanurate, ditrimethylolpropane tetraacrylate, and ditrimethylolpropane triacrylate.

(1-3) A Compound Having at Least One Glycidyl Group and/or Epoxy Group

The Preferable compounds to be used in the present invention having at least one glycidyl group and/or an epoxy group are as follows: an epi-bis-type glycidyl ether type epoxy resin obtained by condensation reaction of a bisphenol such as bisphenol A, bisphenol F, and bisphenol S with epihalohydrin, an a high molecular weight epi-bis-type glycidyl ether type epoxy resin obtained by addition reaction of the above epi-bis-type glycidyl ether type epoxy resin with the above-mentioned bisphenol such as bisphenol A, bisphenol F, and bisphenol S; a novolak-aralkyl type glycidyl ether type epoxy resin obtained by further condensation reaction of epihalohydrin with an polyhydric phenol obtained by condensation reaction of a phenol such as phenol, cresol, xylenol, naphthol, resorcin, catechol, bisphenol A, bisphenol F, and bisphenol S and formaldehyde, acetaldehyde, propionaldehyde, benzaldehyde, hydroxybenzaldehyde, salicylaldehyde, dicyclopentadiene, terpene, cumarin, p-xylylene glycol dimethyl ether, p-dichloroxylylene, bishydroxymethylbiphenyl; an aromatic crystalline epoxy resin such as an aromatic crystalline epoxy resin obtained by condensation reaction of tetramethyl biphenol, tetramethyl bisphenol F, hydroquinone, and naphthalene diol with epihalohydrin and a high molecular weight type of the aromatic crystalline epoxy resin obtained by further subjecting the obtained resin to addition reaction with the bisphenol, tetramethylbiphenol, tetramethylbisphenol F, hydroquinone, and naphthalenediol; an aliphatic glycidyl ether type epoxy resin obtained by condensation reaction of alicyclic glycol derived by hydrogenation of the bisphenol and an aromatic backbone such as tetramethylbiphenol, tetramethylbisphenol F, hydroquinone, and naphthalenediol, ethylene glycol, diethylene glycol, triethylene glycol, tetraethylene glycol, PEG 600, propylene glycol, dipropylene glycol, tripropylene glycol, tetrapropylene glycol, PPG, glycerol, diglycerol, tetraglycerol, polyglycerol, trimethylolpropane and its polymers, pentaerythritol and its polymers, monopoly saccharides such as glucose, fructose, lactose, and maltose with epihalohydrin; an epoxy resin having an epoxycyclohexane backbone such as (3,4-epoxycyclohexane)methyl 3′,4′-epoxycyclohexylcarboxylate; a glycidyl ester type epoxy resin obtained by condensation reaction of tetrahydrophthalic acid, hexahydrophthalic acid, and benzoic acid with epihalohydrin; and a tertiary amine-containing glycidyl ether type epoxy resin in solid-phase at a normal temperature obtained by condensation reaction of hydantoin, cyanuric acid, melamine, and benzoguanamine with epihalohydrin. Among them, the above-mentioned aliphatic glycidyl ether type epoxy resin and the epoxy resin having the epoxycyclohexane backbone are preferable to be used in the case the epoxy resin is used for the purpose of suppressing the appearance deterioration by light radiation.

In the present invention, as curable resins, those containing non-curable components such as thermoplastic resins and curable compound with low molecular weights can be used. Examples of the thermoplastic resins are polyethylene, polypropylene, polystyrene, acrylonitrile-styrene copolymers (AS resins), ABS resins comprising acrylonitrile, butadiene, and styrene, vinyl chloride resins, (meth)acrylic resins, polyamide resins, acetal resins, polycarbonate resins, polyphenylene oxide, polyesters, and polyimides. As the above-mentioned curable compounds, those which are exemplified as the polyhydric phenol compounds, compounds having polymerizable unsaturated bonds, and compounds having at least one of glycidyl group and/or epoxy group may be selected properly.

### (2) Inorganic Fine Particles

The resin composition for the optical packaging material of the present invention contains the above-mentioned resin and an inorganic fine particle and the inorganic fine particle is a hydrolyzed condensate of an alkoxide compound and/or a carboxylic acid salt compound and has an average inertia radius of 50 nm or smaller.

The hydrolyzed condensate compound is defined as a compound obtained by hydrolysis reaction, followed by condensation reaction. Hereinafter, the hydrolysis reaction and condensation reaction of alkoxide compound and carboxylic acid salt compound will be described.

M(OR¹)ₐ+aH₂O (hydrolysis)→M(OH)ₐ+aR¹OH

M(OH)ₐ→M(OH)_{b}O_{c}→MO_{2/c} (condensate)

(wherein M represents a metal element or a non-metal element; R¹ represents an alkyl group or an acyl group; and a, b, and c represent arbitrary numeric value).

As the above-mentioned alkoxide compound and carboxylic acid salt compound, typically preferred is the compound represented by the following general formula (1):

M(OR²)ₙ (1)

(wherein M represents a metal element or a non-metal element; R² represents an alkyl group or an acyl group; and n represents an integer 1 to 7): and/or the compound represented by the following general formula (2):

(R³)ₘM(OR²)ₚ (2)

(wherein M and R² represent same as those defined in the general formula (1); R³ represents an organic group; and m and p represents an integer 1 to 6).

The alkyl group of R² in the above-mentioned general formulae (1) and (2) preferably includes an alkyl having 1 to 5 carbon atoms. Examples of the preferable alkyl group are an ethyl group, a n-propyl group, an isopropyl group, n-butyl group, an isobutyl group, a sec-butyl group, a tert-butyl group, and a n-pentyl group. The acyl group of R² preferably includes an acryl group having 1 to 4 carbon atoms. Examples of the preferable acyl group are acetyl, propionyl, and butyryl and the like.

The organic group represented by R³ in the above-mentioned general formula (2) preferably includes an organic group having 1 to 8 carbon atoms. Examples of the preferable organic group are an alkyl group such as methyl group, n-propyl group, isopropyl group, n-butyl group, isobutyl group, sec-butyl group, tert-butyl group, n-pentyl group, n-hexyl group, n-heptyl group, n-octyl group; a halogenated alkyl group such as 3-fluoropropyl group, 3-chloropropyl group, and 3,3,3-trichloropropyl group; a mercapto-containing alkyl group such as 2-mercaptopropyl group, an amino-containing alkyl group such as 2-aminoethyl group, 2-dimethylaminoethyl group, 3-aminopropyl group, and 3-dimethylaminopropyl group; an aryl group such as phenyl group, methylphenyl group, ethylphenyl group, methoxyphenyl group, ethoxyphenyl group, fluorophenyl group, and chlorophenyl group; an aralkyl group such as benzyl; an epoxy-containing organic group such as 2-glycidoxyethyl group, 3-glycidoxypropyl group, and 2-(3,4-epoxycyclohexyl)ethyl group; and an unsaturated group-containing organic group such as vinyl and 3-(meth)acryloxypropyl group.

The metal element or non-metal element represented by M in the above-mentioned general formulae (1) and (2) include any element in the periodic table as long as it can be the metal element or non-metal element satisfying the structure of the compound defined by the general formulae (1) and (2). Examples of the metal element or non-metal element are IIIB group elements such as B, Al, Ca, In, and TI; IVB group elements such as C, Si, Ge, Sn, and Pb; and Ti, Zr, Zn, Ca, Na, Li, Te, Mg, Ni, Cr, Ba, Ta, Mo, Tb and Cs.

As the above-mentioned alkoxide compound and carboxylic acid salt compound, two or more kinds of the compounds having different M each other may be used in combination. Alternatively, a compound having collectively two or more kinds of M can be used. Especially, in the application of the optical packaging material, an insulating property is required. Thus, it is preferable to select the metal having low ion conductivity. Examples of the metal element or non-metal element for M are preferably a typical metal element excluding alkali metals and alkaline earth metals, and a transition metal element, and a non-metal element. Examples of the preferable typical metal elements excluding alkali metals and alkaline earth metals are Al and In, and Si is preferable as the non-metal element.

Examples of the alkoxide compound and carboxylic acid salt compound where M is Si are a tetraalkoxysilane such as tetramethoxysilane, tetraethoxysilane, tetra-n-propoxysilane, tetra-isopropoxysilane, tetra-n-butoxysilane, tetra-isobutoxysilane, tetra-sec-butoxysilane, and tetra-tert-butoxysilane; a trialkoxysilane such as methyltrimethoxysilane, methyltriethoxysilane, ethyltrimethoxysilane, ethyltriethoxysilane, n-propyltrimethoxysilane, n-propyltriethoxysilane, isopropylmethoxysilane, isopropyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-mercaptopropyltrimethoxysilane, 3-aminopropyltrimethoxysilane, 3-aminopropyltriethoxysilane, N-(2-aminoethyl)-3-aminopropyltrimethoxysilane, N-(2-aminoethyl)-3-aminopropyltriethoxysilane, N-[3-(trimethoxysilyl)propyl]aniline, N-[3-(triethoxysilyl)propyl]aniline, phenyltrimethoxysilane, phenyltriethoxysilane, benzyltrimethoxysilane, benzyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, vinyltrimethoxysilane, vinyltriethoxysilane, 3-(meth)acryloxypropyltrimethoxysilane, and 3-(meth)acryloxypropyltriethoxysilane;

a dialkoxysilane such as dimethyldimethoxysilane, dimethyldiethoxysilane, diethyldimethoxysilane, diethyldiethoxysilane, di-n-propyldimethoxysilane, di-n-propyldiethoxysilane, di-isopropyldimethoxysilane, di-isopropyldiethoxysilane, diphenyldimethoxysilane, and diphenyldiethoxysilane;

a tetraacyloxysilane such as tetraacetyloxysilane and tetrapropionyloxysilane;

a triacyloxysilane such as methyltriacetyloxysilane and ethyltriacetyloxysilane; and

a diacyloxysilane such as dimethyldiacetyloxysilane and diethyldiacetyloxysilane. Among them, tetramethoxysilane, tetraethoxysilane, methyltrimethoxysilane, methyltriethoxysilane, dimethyldimethoxysilane, and dimethyldiethoxysilane are preferable.

Preferable examples of the alkoxide compound where M is other than Si are a single metal alkoxide such as; Cu(OCH₃)₂, Zn(OC₂H₅)₂, B(OCH₃)₃, Al(OCH₃)₃, Al(OC₂H₅)₃, Al(iso-OC₃H₇)₃, Al(OC₄H₉)₃, Ga(OC₂H₅)₃, Y(OC₄H₉)₃, Ge(OC₂H₅)₄, Pb(OC₄H₉)₄, P(OCH₃)₃, Sb(OC₂H₅)₃, VO(OC₂H₅)₃, Ta(OC₃H₇)₅, W(OC₂H₅)₆, La(OC₃H₇)₃, Nb(OC₂H₅)₃, Ti(OCH₃)₄, Ti(OC₂H₅)₄, Ti(iso-OC₃H₇)₄, Ti(OC₄H₉)₄, Zr(OCH₃)₄, Zr(OC₂H₅)₄, Zr(OC₃H₇)₄, and Zr(OC₄H₉)₄; and a composite metal alkoxide such as La[Al(iso-OC₃H₇)₄]₃, Mg[Al(iso-OC₃H₇)₄]₂, Mg[Al(sec-OC₄H₉)₄]₂, Ni[Al(iso-OC₃H₇)₄]₂, (C₃H₇O)₂Zr[Al(OC₃H₇)₄]₂, and Ba[Zr(OC₂H₅)₉]₂.

In order to promote the above-mentioned hydrolysis and condensation reaction, a metal chelate compound may be used. The metal chelate compound can be used alone or in combination of two of them. The metal chelate compound preferably includes one or more compound selected from a group consisting of Zr(OR⁴)_{q}(R⁵COCHCOR⁶)_{4-q}, Ti(OR⁴)ᵣ(R⁵COCHCOR⁶)₄₋ᵣ, and Al(R⁴)ₛ(R⁵COCHCOR⁶)₄₋ₛ and the partially hydrolyzed compounds thereof.

R⁴ and R⁵ of the above-mentioned metal chelate compound are same or different each other and represent an organic group having 1 to 6 carbon atoms; R⁶ represents an organic group having 1 to 6 carbon atoms or an alkoxyl group having 1 to 16 carbon atoms; q and r represent an integer of 0 to 3; and s represents an integer of 0 to 2. Examples of the preferable organic group having 1 to 6 carbon atoms represented by R⁴ and R⁵ are methyl group, ethyl group, n-propyl group, isopropyl group, n-butyl group, isobutyl group, sec-butyl group, tert-butyl group, n-pentyl group, n-hexyl group, and phenyl group. Examples of the preferable alkoxyl group having 1 to 16 carbon atoms represented by R⁶ are methoxy group, ethoxy group, n-propoxy group, isopropoxy group, n-butoxy group, isobutoxy group, sec-butoxy group, and tert-butoxy group.

Examples of the preferable metal chelate compounds are a zirconium chelate compound such as tri-n-butoxy-ethylacetoacetate zirconium, di-n-butoxy-bis(ethylacetoacetate) zirconium, n-butoxy-tris(ethylacetoacetate) zirconium, tetrakis(n-propylacetoacetate) zirconium, tetrakis(acetylacetonate) zirconium, and tetrakis(ethylacetoacetate) zirconium; a titanium chelate compound such as di-isopropoxy-bis(ethylacetoacetate) titanium, di-isopropoxy-bis(acetylacetate) titanium, and di-isopropoxy-bis(acetylacetonate) titanium; and an aluminum chelate compound such as di-isopropoxyethylacetoacetate aluminum, di-isopropoxyacetoacetonate aluminum, isopropoxy-bis(ethylacetoacetate) aluminum, isopropoxy-bis(acetylacetonate) aluminum tris(ethylacetoacetate) aluminum, tris(acetylacetonate) aluminum, and monoacetylacetonate-bis(ethylacetoacetate) aluminum. Among them, tri-n-butoxyethylacetoacetate zirconium, di-isopropoxy-bis(acetylacetonate) titanium, di-isopropoxy-ethylacetoacetate aluminum, tris(ethylacetoacetate) aluminum are preferable.

The amount of the above-mentioned metal chelate compound used is preferably 30 parts or less by weight with respect to 100 parts by weight of the compound defined by the above-mentioned general formula (1) and/or the compound defined by the above-mentioned general formula (2). If the amount exceeds 30 parts by weight, the surface appearance of the molded body may possibly be deteriorated. The amount is more preferably 20 parts or less by weight and even more preferably 10 parts or less by weight.

Since the inorganic fine particle of the present invention is hydrolyzed condensate of the alkoxide compound and/or the carboxylic acid salt compound, they have microstructures different from those of the inorganic fine particle obtained by different reaction mechanism and it can be confirmed by nuclear magnetic resonance (NMR) measurement in the case the inorganic fine particle contain metal elements or non-metal elements such as Si, Al, P, Fe, Ag, Sn, Ti, V, Cr, Mn, Co, Cu, Zn, Sb, and La. As one example, in the case of containing Si, the condensate has the regular tetrahedron composed of SiO₄ where a single Si atom and four oxygen atoms coordinated in the surrounding as the base structure. The microstructure differs depending upon as to whether the SiO₄ atom groups possess oxygen atoms in common or not. In the case silica is produced by heat degradation of silicon halides or air oxidation of heated and reduced silica sand, all SiO₄ atom groups possess oxygen atoms in common. Thus, only the Q⁴ silica component having peak top in a range of −120 ppm to −100 ppm can be observed by Si—NMR measurement. On the other hand, in the case of the hydrolyzed condensate of the alkoxide compound and/or the carboxylic acid salt compound described in the present invention, SiO₄ atom groups which do not possess oxygen atoms in common appear, the Q³ silica component having peak top in a range of −100 ppm to −90 ppm can also be confirmed in addition to Q⁴ silica component. Such NMR measurement can be effective means of confirming whether the inorganic fine particle is the hydrolyzed condensate compound of the alkoxide compounds and/or carboxylic acid salt compounds or not, and is capable of investigating to what extent the inorganic fine particle provides the various performances as expected by the inorganic fine particle.

The inorganic fine particle to be used in the present invention have an (weight) average inertia radius of 50 nm or smaller, more preferably 45 nm or smaller, and even more preferably 40 nm or smaller. Dispersing the inorganic fine particle having an (weight) average inertia radius of 50 nm or smaller in the resin can lower the coefficient of thermal expansion of the optical packaging material. The method for preparing “the inorganic fine particle obtained by hydrolyzing and condensing the alkoxide compound and/or the carboxylic acid salt compound and having an average inertia radius of 50 nm or smaller” to be used in the present invention preferably includes a method comprising hydrolyzing and condensing the alkoxide compound and/or the carboxylic acid salt compound in a liquid medium containing the above-mentioned resin component to obtain the inorganic fine particle. Generating the hydrolyzed condensate in the liquid medium containing the resin component allows the organic-inorganic composite, and thus gives the organic-inorganic hybrid (composite) of the resin composition for the optical packaging material of the present invention, where the inorganic fine particle is finely dispersed into the matrix resin. The organic-inorganic hybrid obtained in such a manner exhibits excellent curability and flame retardancy.

The specific method for producing the above-mentioned inorganic fine particle comprises, for example, preparing the liquid medium containing the resin, preferably a solution containing the resin at first, adding the alkoxide compound and/or the carboxylic acid salt compound together with water or the solvent containing water to the solution, and then carrying out the hydrolysis reaction and condensation reaction. As the liquid medium containing the above-mentioned resin component, preferably used is a compound having at least one structure selected from a group consisting of an ether bond, an ester bond, and nitrogen atom.

Examples of the preferable compound having the ether bond are diethyl ether, dipropyl ether, diisopropyl ether, dibutyl ether, dihexyl ether, ethyl vinyl ether, butyl vinyl ether, anisole, phenetole, butyl phenyl ether, pentyl phenyl ether, methoxytoluene, benzyl ethyl ether, diphenyl ether, dibenzyl ether, peratrol, propylene oxide, 1,2-epoxybutane, dioxane, trioxane, furan, 2-methylfuran, tetrahydrofuran, tetrahydropyran, cionel, 1,2-dimethoxyethane, 1,2-diethoxyethane, 1,2-dibutoxyethane, glycerin ether, crown ether, methylal, acetal, methylcellosolve, ethyulcellosolve, butylcellosolve, ethylene glycol monopropyl ether, ethylene glycol monohexyl ether, ethylene glycol dimethyl ether, diethylene glycol, diethylene glycol methyl ether, diethylene glycol ethyl ether, diethylene glycol butyl ether, diethylene glycol dimethyl ether, diethylene glycol diethyl ether, diethylene glycol dibutyl ether, triethylene glycol, triethylene glycol monomethyl ether, tetraethylene glycol, 1-methoxy-2-propanol, 1-ethoxy-2-propanol, propylene glycol methyl ether, propylene glycol dimethyl ether, propylene glycol propyl ether, propylene glycol butyl ether, dipropylene glycol, dipropylene glycol monomethyl ether, dipropylene glycol monoethyl ether, dipropylene glycol dimethyl ether, dipropylene glycol diethyl ether, dipropylene glycol dibutyl ether, tripropylene glycol, tripropylene glycol monomethyl ether, 2-methoxyethanol, 2-ethoxyethanol, 2-(methoxymethoxy)ethanol, 2-isopropoxyethanol, 2-butoxyethanol, 2-(isopentyloxy)ethanol, 2-(hexyloxy)ethanol, 2-phenoxyethanol, 2-(benzyloxy)ethanol, furfuryl alcohol, and tetrahydrofurfuryl alcohol.

Examples of the preferable compound having the ester bond are methyl formate, ethyl formate, propyl formate, butyl formate, isobutyl formate, pentyl formate, methyl acetate, ethyl acetate, propyl acetate, isopropyl acetate, butyl acetate, isobutyl acetate, sec-butyl acetate, pentyl acetate, isopentyl acetate, 3-methoxybutyl acetate, sec-hexyl acetate, 2-ethylbutyl acetate, 2-ethylhexyl acetate, cyclohexyl acetate, benzyl acetate, methyl propionate, ethyl propionate, butyl propionate, isopentyl propionate, ethylene glycol monoacetate, diethylene glycol monoacetate, monoacetin, diacetin, triacetin, monobutylin, dimethyl carbonate, diethyl carbonate, dipropyl carbonate, dibutyl carbonate, butyric acid esters, isobutyric esters, isovaleric esters, stearic acid esters, benzoic acid esters, cinnamic acid ethyls, abietic acid esters, adipic acid esters, γ-butyrolactones, oxalic acid esters, malonic acid esters, maleic acid esters, tartaric acid esters, citric acid esters, sebacic acid esters, phthalic acid esters, diacetic acid ethylenes.

Examples of the preferable compound containing a nitrogen atom are nitromethane, nitroethane, 1-nitropropane, 2-nitropropane, nitrobenzene, acetonitrile, propionitrile, succinonitrile, butyronitrile, isobutyronitrile, valeronitrile, benzonitrile, α-tolunitrile, formamide, N-methylformamide, N,N-dimethylformamide, N,N-diethylformamide, acetamide, N-methylacetamide, N,N-dimethylacetamide, N,N-diethylacetamide, 2-pyrrolidone, N-methylpyrrolidone, and ε-caprolactam.

Examples of the preferable compound having a plurality of structures selected from a group consisting of an ether bond, an ester bond, and a nitrogen atom are N-ethylmorpholine, N-phenylmorpholine, methylcellosolve acetate, ethylcellosolve acetate, propylcellosolve acetate, butylcellosolve acetate, phenoxyethyl acetate, diethylene glycol monomethyl ether acetate, diethylene glycol monoethyl ether acetate, diethylene glycol monopropyl ether acetate, diethylene glycol monobutyl ether acetate, propylene glycol methyl ether acetate, propylene glycol ethyl ether acetate, propylene glycol propyl ether acetate, propylene glycol butyl ether acetate, dipropylene glycol methyl ether acetate, dipropylene glycol ethyl ether acetate, dipropylene glycol propyl ether acetate, dipropylene glycol butyl ether acetate, and tripropylene glycol methyl ether acetate.

The amount of the above-mentioned solvent used is preferably 5 parts or more by weight and 500 parts or less by weight with respect to 100 parts by weight of the resin. The amount is more preferably 20 part or more by weight and 200 part or less by weight. As other solvents, methanol and ethanol and the like are preferable.

In the reaction condition of the hydrolysis and condensation in the above-mentioned liquid medium containing the resin, the reaction temperature is preferably from 0 to 120° C., more preferably from 10 to 100° C., and even more preferably from 20 to 80° C. The reaction time is preferably from 30 minutes to 24 hours, more preferably from 1 to 12 hours. In the reaction condition in the case of producing the above-mentioned inorganic fine particle, the reaction temperature may properly be adjusted in accordance with resultant the inorganic fine particle and the reaction pressure may be normal pressure or elevated pressure, however in the present invention, the reaction temperature is adjusted to be 100° C. or lower, preferably from 50 to 100° C., more preferably from 70 to 100° C. and the reaction pressure is adjusted to be normal pressure, and the reaction time is adjusted to be from 4 to 10 hours.

The resin composition for the optical packaging material of the present invention preferably contains the inorganic fine particle in an amount of 1% or more by weight, more preferably 5% or more by weight, and preferably in an amount of 50% or less by weight, more preferably 40% or less by weight. If the amount is less than 1% by weight, the effects to improve the flame retardancy and the thermal properties of the obtained optical packaging material may possibly not be exhibited. If the amount exceeds 50% by weight, the resin composition becomes highly viscous. As a result, it is difficult to mix the composition uniformly.

The resin composition for the optical packaging material of the present invention preferably may further contain an inorganic compound having a weight average particle size of 0.1 μm or larger, more preferably 1 μm or larger, and a weight average particle size of 100 μm or smaller, more preferably 50 μm or smaller. Use of the inorganic compound in combination makes the effect of improving the flame retardancy, the thermal property (coefficient of thermal expansion), and mechanical property of the molded body which are imparted by the inorganic fine particles more significant. Further, the coefficient of thermal expansion of the molded body obtained from the optical packaging material can be controlled by controlling the amount of the inorganic compound having the weight average particle size of 0.1 μm to 100 μm. The content of the inorganic compound having a weight average particle size of 0.1 μm to 100 μm is preferably 2% or more by weight, more preferably 5% or more by weight and preferably less than 95% by weight, more preferably 90% or less by weight, in the resin composition for the optical packaging material. Adjustment of the content of the inorganic compound within the above-mentioned range makes it possible to control the coefficient of thermal expansion from that (about 40 to 60 ppm) of a polymer material such as poly methyl methacrylate and polyimide to that (8 ppm) of a quartz type material.

In this embodiment, the ratio of the entire inorganic components contained in the resin composition for the optical packaging material of the present invention is considerably enhanced by using the inorganic materials which are different in the particle size each other in combination, like the fine particle having an average inertia radius of 50 nm or smaller and the inorganic compound having a weight average particle diameter of 0.1 μm to 100 μm. Accordingly, the coefficient of thermal expansion of the resultant optical packaging material can be lowered to a level almost same as that of an inorganic material such as quartz or Pyrex (registered trade name) and the flame retardancy is improved. That is, adjusting the content of the inorganic compound having a weight average particle size of 0.1 μm to 100 μm from 80% (inclusive) to 95% (exclusive) by weight enables the resultant optical packaging material to have a coefficient of thermal expansion of 10 ppm or lower.

It is preferable to use a ceramic having a coefficient of thermal expansion of 10 ppm or lower as the inorganic compound. Use of the ceramic with a low coefficient of thermal expansion provides the resultant optical packaging material with the low coefficient of thermal expansion. Examples of the ceramic having the coefficient of thermal expansion of 10 ppm or lower are an amorphous silica having a coefficient of thermal expansion about 0.5 ppm, cordierite about 1.0 ppm, and β-eucryptite about −8 ppm. Among them, fused silica, which is the amorphous silica, is preferable to be used.

The resin composition for the optical packaging material of the present invention may further contain, in addition to the above-mentioned resin and the inorganic fine particle, a curing-promoting agent, a reactive diluent, a saturated compound having no unsaturated bond, a pigment, a dye, an antioxidant, an ultraviolet absorbent, a photostabilizer, a plasticizer, a non-reactive compound, a chain transfer agent, a thermal polymerization initiator, an anaerobic polymerization initiator, a polymerization inhibitor, an inorganic and organic filler, an adhesion promoter such as a coupling agent, a heat stabilizer, an anti-bacterial and anti-mold agent, a flame retardant, a delustering agent, a defoaming agent, a leveling agent, a wetting and dispersing agent, a precipitation prevention agent, a thickener, an anti-flowing agent, a color separation prevention agent, an emulsifier, a slipping and scratching prevention agent, a skimming prevention agent, a drying agent, an anti-staining agent, an antistatic agent, a conductive agent (electrostatic assisting agent) and the like.

### (3) Method for Curing Resin Composition for Optical Packaging Material

Hereinafter, a method for curing the resin composition for the optical packaging material of the present invention will be described. Depending on the properties of the resin to be used, a well known method can be employed to cure the resin composition for the optical packaging material of the present invention.

### (3-1) In the Case of Polyhydric Phenol Compound

The resin composition for the optical packaging material of the present invention containing a polyhydric phenol compound as a resin component can be a cured body by thermosetting using a curing agent. The compound having at least two glycidyl groups and/or epoxy groups can be exemplified as the curing agent. The epoxy resin having two or more glycidyl groups and/or epoxy groups in average per one molecule is preferable as the compound having at least two glycidyl groups and/or epoxy groups. Preferable examples are an epi-bis-type glycidyl ether type epoxy resin obtained by condensation reaction of bisphenols such as bisphenol A, bisphenol F, and bisphenol S with epihalohydrin; a novolak-aralkyl type glycidyl ether type epoxy resin obtained by condensation reaction of epihalohydrin with a polyhydric phenol obtained by condensation reaction of a phenol such as phenol, cresol, xylenol, resorcin, catechol, bisphenol A, and bisphenol F and formaldehyde, acetaldehyde, propionaldehyde, benzaldehyde, salicylaldehyde, dicyclopentadiene, terpene, cumarin, p-xylylene dimethyl ether, and p-dichloroxylylene; a glycidyl ester type epoxy resin obtained by condensation reaction of tetrahydrophthalic acid, hexahydrophthalic acid and benzoic acid with epihalohydrin; a glycidyl ether type epoxy resin obtained by condensation reaction of a hydrogenated bisphenol and glycol with epihalohydrin; an amine-containing glycidyl ether type epoxy resin obtained by condensation reaction of hydantoin and cyanuric acid with epihalohydrin; and an aromatic polycyclic epoxy resin such as biphenyl type epoxy resin and naphthalene type epoxy resin. Further, examples may include a compound containing an epoxy group in a molecule which compound is obtained by addition reaction of the above epoxy resin with polybasic acid and/or bisphenol. They may be used alone or two or more of them.

The mixing ratio by weight of the above-mentioned polyhydric phenol compound and the epoxy resin type curing agent (polyhydric phenol compound/epoxy resin type curing agent) is preferable to be adjusted to 30/70 or higher and 70/30 or lower. If the mixing ratio is less than 30/70, the mechanical properties of the cured product of the mixture may possibly be lowered and if the mixing ratio exceeds 70/30, the flame retardancy may possibly become insufficient. The mixing ratio is more preferably 35/65 or higher and 65/35 or lower. A curing accelerator may be used for the curing. Examples of the preferable curing accelerator are an imidazole such as 2-methylimidazole and 2-ethyl-4-methylimidazole; an amine such as 2,4,6-tris(dimethylaminomethyl)phenol, benzylmethylamine, DBU (1,8-diazabicyclo[5,4,0]-7-undecene), and DCMU (3-(3,4-dichlorophenyl)-1,1-dimethylurea); and an organic phosphorus compound such as tributylphosphine, triphenylphosphine, and tris(dimethoxyphenyl)phosphine.

### (3-2) In the Case of Containing a Compound Having a Polymerizable Unsaturated Bond

The method for curing the resin composition for the optical packaging material containing the compound having a polymerizable unsaturated bond as the resin component includes for example a curing method by active energy beam irradiation and a curing method by heat. Since the resin composition of the present invention has an intrinsic spectral responsiveness in a range of 200 to 400 nm and in the absence of a photopolymerization initiator, polymerization can be carried out by irradiating the ultraviolet ray or visible light ray with wavelength of 180 to 500 nm and specially, light with wavelength of 254 nm, 308 nm, 313 nm, and 365 nm is effective for curing and therefore, the curing method by active energy beam irradiation is preferable. Further, since the resin composition of the present invention can be cured in air and/or an inert gas.

The resin composition of the present invention containing the compound having a polymerizable unsaturated bond can be cured by irradiation of active energy beam which can produce radical species besides ultraviolet rays or visible light rays. Ionization radiation beams such as electron beam, α-rays, β-rays, and γ-rays; microwave, high frequency, infrared rays, and laser beams are preferable besides ultraviolet rays or visible light rays, and may adequately be selected in consideration of the absorption wavelength of the compound to generate the radical active species.

A low pressure mercury lamp, a high pressure mercury lamp, an ultrahigh pressure mercury lamp, a metal halide lamp, a chemical lamp, a black light lamp, a mercury-xenon lamp, an excimer lamp, a short arc lamp, helium-cadmium laser, argon laser, excimer laser, and sun rays are preferable as the light generation source for ultraviolet rays or visible light rays with the wavelength of 180 to 500 nm. The irradiation time of the ultraviolet rays or visible light rays with the wavelength of 180 to 500 nm may properly be set depending on the active energy beam irradiation and it is preferably 0.1 μsecond to 30 minutes and more preferably 0.1 ms to 1 minute.

In the above-mentioned curing by irradiation of active energy beam, a conventionally known photopolymerization initiator may be added so as to carry out the curing reaction more efficiently. The addition amount of the above-mentioned photopolymerization initiator is preferably 0.1 part by weight to 10 parts by weight to the curable resin component of the present invention 100 part by weight. If it is less than 0.1 part by weight, the photopolymerization may possibly not be promoted well and if it exceeds 10 parts by weight, no further improvement effect on curing speed is provided and rather contrarily, the curing may possible become insufficient.

The above-mentioned photopolymerization initiator may include an intermolecular bond cleavage type photopolymerization initiator and an intermolecular hydrogen abstraction type photopolymerization initiator. Examples of intermolecular bond cleavage type photopolymerization initiators are an acetophenone type one such as diethoxyacetophenone, 4-(2-hydroxyethoxy)phenyl-(2-hydroxy-2-propyl) ketone, 2-methyl-2-morpholino(4-thiomethylphenyl)propan-1-one (Irgacure 907, manufactured by Ciba-Geigy Corp.), 2-benzyl-2-dimethylamino-1-(4-morpholinophenyl)-butanone, 2-hydroxy-2-methyl-1-phenylpropan-1-one (Darocure 1173, manufactured by Merck & Co., Inc.), 1-hydroxycyclohexyl phenyl ketone (Irgacure 184, manufactured by Ciba-Geigy Corp.), 1-(4-isopropylphenyl)-2-hydroxy-2-methylpropan-1-one (Darocure 1116, manufactured by Merck & Co., Inc.), benzyl dimethyl ketal (Irgacure 651, manufactured by Ciba-Geigy Corp.), oligo{2-hydroxy-2-methyl-1-[4-(1-methylvinyl)phenyl]propane} (Esacure KIP100, manufactured by Lamberti), and 4-(2-acryloyl-oxyethoxy)phenyl 2-hydroxy-2-propyl ketone (ZLI 3331, manufactured by Ciba-Geigy Corp.); a benzoine derivative such as benzoine, benzoine isopropyl ether, benzoine isobutyl ether, and benzoine alkyl, a mixture of 1-hydroxycyclohexyl phenyl ketone and benzophenone (Irgacure 500, manufactured by Ciba-Geigy Corp.); an acylphosphine oxide type one such as 2,4,6-trimethylbenzoyldiphenylphosphine oxide (Lucirin TPO, manufactured by BASF), bisacylphosphine oxide (CGI1700, manufactured by Ciba-Geigy Corp.); benzyl and benzyl derivatives, methyl phenyl glyoxyester, 3,3′,4,4′-tetra(tert-butylperoxycarbonyl)benzophenone (BTTB, manufactured by Nippon Oil and Fats Co., Ltd.).

Preferable examples of the intermolecular hydrogen abstraction type photopolymerization initiators are a benzophenone type such as benzophenone, methyl o-benzoylbenzoate and alkyl o-benzoylbenzoate, 4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(tert-butylperoxycarbonyl)benzophenone, and 3,3′-dimethyl-4-methoxybenzophenone; a thioxanthone type such as 2-isopropylthioxanthone, 2,4-dimethylthioxanthone, 2,4-diethylthioxanthone, and 2,4-dichlorothioxanthone; aminobenzophenone types such as Michler's ketone and 4,4′-diethylaminobenzophenone; 10-butyl-2-chloroacrydone, 2-ethylanthraquinone, 9,10-phenanethrenequinone, and camphor quinone.

Other compounds to be used as the above-mentioned photopolymerization initiators may include preferably 2,2-dimethoxy-1,2-diphenylethan-1-one, 1-hydroxy-cycloehxyl-phenyl-ketone, 2-methyl-1-[4-(methylthio)phenyl]-2-morpholonopropanone-1,2-hydroxy-2-methyl-1-phenyl-propan-1-one and its derivatives, 4-dimethylaminobenzoate ester, 1,1-dialkoxyacetophenone, benzophenone and benzophenone derivatives, alkyl benzoyl benzoate, bis(4-dialkylaminophenyl) ketone, benzyl and benzyl derivatives, benzoine and benzoine derivatives, benzoine alkyl ether, 2-hydroxy-2-methylpropiophenone, thioxanthone and thioxanthone derivatives, 2,4,6-trimethylbenzoyldiphenylphosphine oxide, 2-benzyl-2-dimethylamino-1-(4-morpholinophenyl)-butanone-1, bis(2,6-dimethoxybenzoyl)-2,4,4-trimethylpentylphosphine oxide, and bis(2,4,6-trimethylphenyl)-phenylphosphine oxide.

A photo cation polymerization initiator may also be used as the above-mentioned photopolymerization initiator. Preferable examples of the photo cation polymerization initiator are triphenylsulfonium hexafluoroantimonate, triphenylsulfonium phosphate, p-(phenylthio)phenyldiphenylsulfonium hexafluoroantimonate, p-(phenylthio)phenyldiphenylsulfonium hexafluorophosphate, 4-chlorophenyldiphenylsulfonium hexafluorophosphate, 4-chlorophenyldiphenylsulfonium hexafluoroantimonate, bis[4-(diphenylsulfonio)phenyl]sulfidobishexafluorophosphate, bis[4-(diphenylsulfonio)phenyl]sulfidobishexafluoroantimonate, (2,4-cyclopentadien-1-yl)[(1-methylethyl)benzene]-Fe-hexafluorophosphate, diallyliodonium hexafluoroantimonate. They can be available in market and SP-150 and SP-170 (manufactured by Asahi Denka Kogyo K.K.), Irgacure 261 (manufactured by Ciba-Geigy Corp.), UVR-6974 and UVR 6990 (manufactured by Union Carbide Corp.), and CD-1012 (manufactured by Sartomer Co., Inc.) are preferable. Among them, onium salts are preferable to be used as the photo cation polymerization initiator. As the onium salts are preferably at least one of arylsulfonium salts and diaryl iodonium salts.

In the above-mentioned curing by radiation of active energy beam, it is preferable to use a photosensitizer in combination. The addition amount of the photosensitizer is preferably 0.1 to 20% by weight to the resin composition of the present invention 100% by weight. If the amount is less than 0.1% by weight, the photo polymerization may possibly not be promoted efficiently and if the amount exceeds 20% by weight, it prevents; ultraviolet lays transmitting into the coating film and the curing may be insufficient. The amount is more preferably 0.5 to 10% by weight.

Examples of the preferable photosensitizer are an amine such as triethanolamine, methyldiethanolamine, triisopropanolamine, methyl 4-dimethylaminobenzoate, ethyl 4-dimethylaminobenzoate, isoamyl 4-dimethylaminobenzoate, (2-dimethylamino)ethyl benzoate, (n-butoxy)ethyl 4-dimethylaminobenzoate, and 2-ethylhexyl 4-dimethylaminobenzoate.

In the curing of the resin composition of the present invention containing the polymerizable unsaturated compound, another additive may be added and the examples of the additive are a curing-promoting agent, a reactive diluent, a saturated compound having no unsaturated bond, a pigment, a dye, an antioxidant, an ultraviolet absorbent, a photostabilizer, a plasticizer, a non-reactive compound, a chain transfer agent, a thermal polymerization initiator, an anaerobic polymerization initiator, a polymerization inhibitor, an inorganic and organic filler, a close adhesion improver such as a coupling agent, a heat stabilizer, an anti-bacterial and anti-mold agent, a flame retardant, a delustering agent, a defoaming agent, a leveling agent, a wetting and dispersing agent, a precipitation prevention agent, a thickener, an anti-flowing agent, a color separation prevention agent, an emulsifier, a slipping and scratching prevention agent, a skimming prevention agent, a drying agent, an anti-staining agent, an antistatic agent, a conductive agent (electrostatic assisting agent) and the like.

(3-3) In the Case of Compound Having at Least One of Glycidyl Group and/or Epoxy Group

The resin composition for the optical packaging material of the present invention containing the compound having at least one of glycidyl group and/or epoxy group as the resin component can be cured by thermal curing using a curing agent to provide a cured product. The curing agent includes one or at least two of the compounds selected from an acid anhydride such as methyltetrahydrophthalic anhydride, hexahydrophthalic anhydride, methylhexahydrophthalic anhydride, pyromellitic anhydride, and methylnadic acid; a phenol resin such as phenol novolak resin, cresol novolak resin, bisphenol A novolak resin, dicyclopentadiene phenol resin, phenol aralkyl resin, land terpene phenol resin; various kinds of phenol resins such as a polyhydric phenol resin obtained by condensation reaction of various kinds of phenols with an aldehyde such as hydroxybenzaldehyde, crotonaldehyde, and glyoxal; BF₃ complex, a sulfonium salt, an imidazole. It is also preferable to cure the compound having at least one of glycidyl group and/or epoxy group by the above-mentioned polyhydric phenol compound.

In the case of curing the resin composition for the optical packaging material of the present invention containing the compound having at least one of glycidyl group and/or epoxy group, a curing agent may be used and for example, one or at least two of organic phosphorus compounds such as triphenylphosphine, tributylhexadecylphosphosnium bromide, tributylphosphine, and tris(dimethoxyphenyl)phosphine are preferable to be used.

The curing temperature is preferably 70 to 200° C. It is more preferably 80 to 150° C. The curing duration is preferably 1 to 15 hours, more preferably 5 to 10 hours.

### (4) Optical Packaging Material, Molded Body of Optical Packaging Material, Optical Packaging Component, and Optical Module

In the present invention, “the optical packaging material” is not particularly limited as long as it is a material capable of being used for an optical fiber communication and includes for example a molded member constituting the optical packaging component such as an optical fiber array, a micro hole array, an optical waveguide device, an optical connector, and a lens array, and also includes an adhesive used for assembling the optical packaging components. It is preferable to use the molded body obtained by curing the above-mentioned resin composition for the optical packaging material of the present invention as the molded member constituting the optical packaging component. The optical packaging component of the present invention is not particularly limited as long as it uses the above-mentioned optical packaging material. Specific examples of the optical packaging component are an optical fiber array, a micro hole array, an optical waveguide device, an optical connector, a lens array, and a box housing them using the above-mentioned optical packaging material.

The molded body of the optical packaging material of the present invention has a coefficient of thermal expansion of 80 ppm or lower, more preferably 60 ppm or lower, and even more preferably 10 ppm or lower at the glass transition temperature or lower. According to the present invention, the molded body of the optical packaging material having the coefficient of thermal expansion almost same as those of quartz and Pyrex (registered trade name) can be obtained and even if the molded body of the present invention is used in combination with the material of quartz and Pyrex (registered trade name), a problem of shift of an optical axis due to temperature fluctuation scarcely occurs.

The optical packaging material to be used for optical fiber communication is required to have the flame retardancy. Since the optical packaging material obtained by curing the resin composition of the present invention is provided with excellent flame retardancy by dispersing the inorganic fine particle in a fine size in the resin, there is an advantage that it is unnecessary to use halogen type, phosphorus type or antimony type flame retardant which causes harmful effects to environments.

The molded body of the optical packaging material of the present invention is not particularly limited, however it is preferable to have the flame retardancy of V-1 or higher, more preferably V-0, defined by UL-94.

The present invention includes the following modified embodiment. That is, the present invention provides the halogen free resin molded body for the optical packaging material having flame retardancy of V-1 or higher defined by UL-94 and a coefficient of thermal expansion of 80 ppm or lower at the glass transition temperature of lower. Herein, “halogen free” means that the halogen content in the molded body is 900 ppm or lower. The halogen-free resin molded body is obtained by molding the above-mentioned resin composition for the optical packaging material of the present invention without using a halogen type flame retardant.

### (5) Method for Preparing the Molded Body of the Optical Packaging Material

The method for preparing the molded body of the optical packaging material comprises pressure-molding the resin composition for the optical packaging material containing the resin and the inorganic fine particle wherein the inorganic fine particle is the hydrolyzed condensate of the alkoxide compound and/or the carboxylic acid salt compound and has an average inertia radius of 50 nm or smaller.

The pressure molding includes, for example, press molding and injection molding. The press molding is preferable. The pressure for the press molding is preferably from 1 atm (0.1 MPa) to 100 atm (10 MPa), more preferably from 5 atm (0.5 MPa) to 80 atm (8 MPa), and even more preferably from 10 atm (1 MPa) to 50 atm (5 MPa). The temperature of the pressure molding is preferably from 80° C. to 250° C. and more preferably from 100° C. to 200° C.

### (6) Optical Packaging Component

Hereinafter, the optical packaging component of the present invention will be described in detail with reference to drawings, however it is not construed that the present invention be limited to the embodiments illustrated in the drawings.

FIG. 3 shows a front view exemplifying an embodiment of the optical packaging material of the present invention used for the optical fiber array. The optical fiber array 1′ is composed of a first substrate 7, optical fibers 5, and a photo and/or thermosetting adhesive layer 13, and a second substrate 11 and the first substrate 7 is provided with V-shaped grooves 9 for placing the optical fibers 5, and the optical fibers 5 are embedded therein. The optical fibers 5 are fixed by the photo and/or thermosetting adhesive layer 13 and the V-shaped grooves 9. In this embodiment, the resin composition for the optical packaging material of the present invention may be used for at least one of the substrates 7 and 11 and the photo and/or thermosetting adhesive layer 13 for the optical fiber array and for example. That is, the present invention may include an embodiment where the resin composition for the optical packaging material of the present invention is used for the first substrate 7 and the photo and/or thermosetting adhesive layer 13 and a substrate made of quartz is used as the second substrate 11. Among these embodiments, it is preferable to use the resin composition of the present invention for all of the first substrate 7, the second substrate 11, and the photo and/or thermosetting adhesive layer 13.

The optical fiber array using the optical packaging material of the present invention has a coefficient of thermal expansion approximately same as that of quartz and Pyrex (registered trade name) and therefore, if it is connected with an optical waveguide made of quartz and Pyrex (registered trade name), a problem of shift of the optical axis following the temperature fluctuation scarcely occurs. Further, when forming a substrate having V-shape grooves for the optical fiber array, it is general to form the V-shaped grooves in the first substrate (a lower substrate) composing the optical fiber array, however it is not necessarily limited to such an embodiment and the V-shaped grooves may be formed only in the second substrate (an upper substrate) and the V-shaped grooves may be formed in both of the first substrate and the second substrate.

To produce the V-shaped groove substrate for the optical fiber array, it may be carried out by cutting the molded body of the optical packaging material with an optional shape into a prescribed size using a diamond cutter, then subjecting the cut product to the mechanical processing such as grinding and polishing to form the V-shaped grooves for placing the optical fibers. However, it is preferable to cure and mold the resin composition for the optical packaging material of the present invention simultaneously by using a die provided with projected and recessed patterns which forms desired V-shaped grooves in the substrate for the optical fiber array. Such a method enables a stable mass production of the V-grooved substrate for the optical fiber array with a high dimensional precision. The shape of the grooves to be formed in the substrate is not necessarily limited to V-shaped and can properly be changed to be U-shaped or rectangular if necessary.

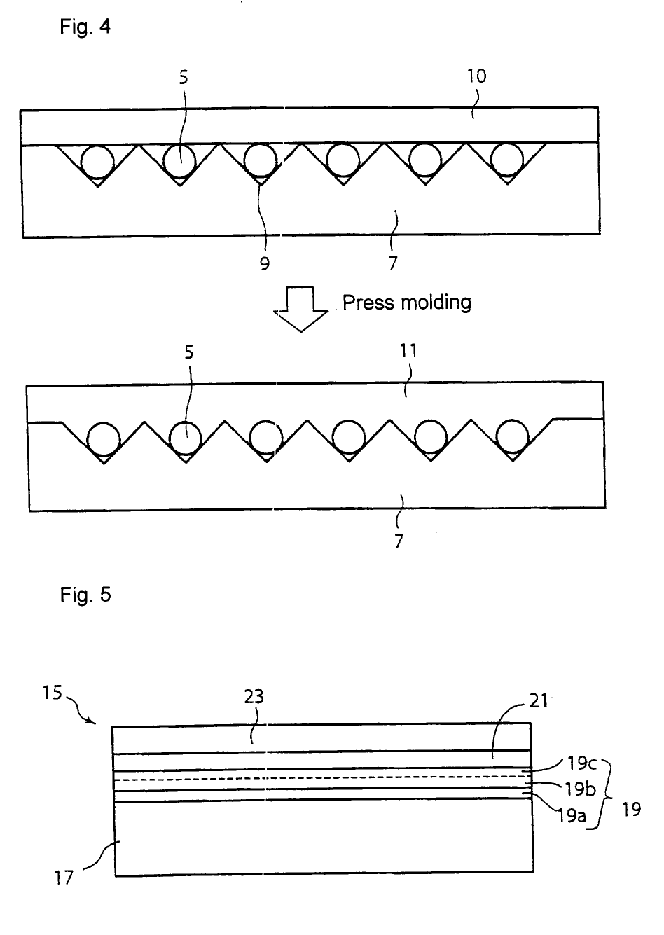

FIG. 4 shows a modified example of the optical fiber array of the present invention. The optical fiber array of this embodiment is composed of optical fibers 5, a first substrate 7 and a second substrate 11. In this embodiment, the optical fibers 5 are placed in grooves of the previously produced V-grooved substrate (the first substrate 7) and then the optical packaging material 10 previously formed into a sheet-like shape is put thereon and press-molded to cure the sheet-like material to fix the optical fibers 5 and form the second substrate 11 simultaneously. This embodiment is preferable since the fixation and formation are simultaneously carried out.

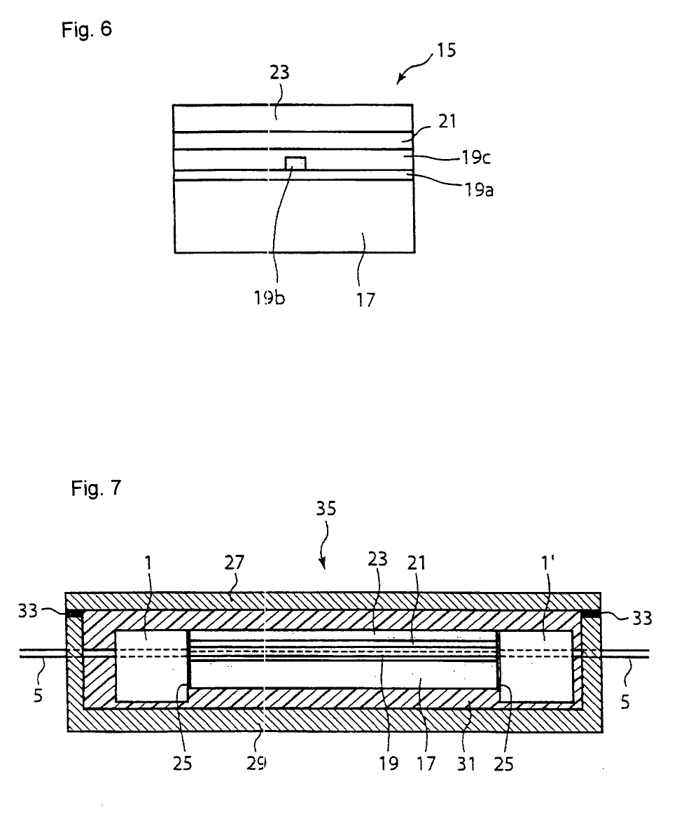

FIG. 5 and FIG. 6 show a side view and a front view showing an embodiment using the optical packaging material of the present invention for the optical waveguide device, respectively. The optical waveguide device 15 comprises a first substrate 17 for the optical waveguide, the optical waveguide circuit 19, the photo and/or thermosetting adhesive layer 12, and the second substrate 23 for the optical waveguide. The optical waveguide circuit 19 further comprises a lower part clad 19a, an upper part clad 19c, and a core 19b and the core 19b is embedded between the lower part clad 19a and the upper part clad 19c. In this embodiment, the resin composition for the optical packaging material of the present invention may be used for at least one of the substrates 17 and 23 for the optical waveguide, the optical waveguide circuit 19, and the photo and/or thermosetting adhesive layer 21 and it is preferable to use the resin composition of the present invention for all of the substrates 17 and 23 for the optical waveguide, the optical waveguide circuit 19, and the photo and/or thermosetting adhesive layer 21. In the embodiment shown in FIG. 5, the second substrate 23 (the upper substrate) for the optical waveguide is formed on the entire face of the optical waveguide, however the second substrate 23 (the upper substrate) for the optical waveguide may be formed on only a part of the optical waveguide, for example, may be formed in about 3 to 5 mm width from the end faces of the waveguide to be connected to the fiber array.

A desired circuit may be set in the optical waveguide circuit 19. Examples of the circuit are a straight waveguide, a bent waveguide, a crossing waveguide, a branching waveguide, and a combination thereof. The optical waveguide circuit may further include an optical packaging component such as a wavelength selection filter, an optical switch, a laser light source, LED, and a light receiving element, an electronic component such as computing and controlling IC, and an electric circuit for operating these electronic components. The electric circuit may be formed directly in the optical waveguide circuit or connected to the optical waveguide circuit via a connector and electric interconnection. It is also preferable to form V-shaped grooves for fiber connection in the inlet side and the outlet side of the optical waveguide simultaneously when molding the substrates for the optical waveguide (the first substrate and/or the second substrate).

The optical module of the present invention is composed of a plurality of the above-mentioned optical packaging components and replaceable as an independent component uniting the above optical packaging components. Examples of the optical module are a 1×n wavelength division multiplexing device, an optical switch, ONU (optical network unit), a WDM filter, an alignator, and an isolator. FIG. 7 is a side view showing a 1×n wavelength division multiplexing device (optical module) for modulating (branching and combining) one channel optical signals to n-channel optical signals. The 1×n wavelength division multiplexing device is composed of a one-channel optical fiber array 1, an n-channel optical fiber array 1′, and an optical waveguide device 15. In FIG. 7, the respective optical fiber arrays 1 and 1′ and the optical waveguide device 15 are fixed by an optical and/or thermosetting adhesive 25 and housed in the housings 27 and 29 and sealed by a sealing agent 31. If necessary, the housing cover 27 may be adhered by a sealing agent 33. In the present invention, the resin composition for the optical packaging material of the present invention may be used for the optical and/or thermosetting adhesive 25, housings 27 and 29, and the seal agents 31 and 33.

### (7) Optical Waveguide Device

The optical waveguide device of the present invention may be a device comprising at least one of the molded members constituting the device and the adhesive is produced by curing the above-mentioned resin composition for the optical packaging material of the present invention. For example, the optical waveguide device includes a device comprising an optical waveguide having a core and a clad and in which at least one of the core and the clad is produced by curing the above-mentioned resin composition for the optical packaging material of the present invention, and an optical waveguide device of which at least one of the substrates (corresponding to the first substrate and the second substrate in FIG. 5) is produced by curing the above-mentioned resin composition for the optical packaging material of the present invention.

In the embodiment of the optical waveguide device provided with an optical waveguide having a core and a clad wherein at least one of the core and the clad is produced by the resin composition for the optical packaging material of the present invention, since the inorganic fine particle have the inertia average radius so small as 50 nm or smaller is dispersed into the resin composition for the optical packaging material of the present invention, the composition has a light transmitting property and thus is preferably used such a molded member as the core or the clad of the optical waveguide. In the case that the resin composition of the present invention is used as the core or the clad of the optical waveguide, the refractive index of the obtained core or the clad can be controlled by changing the content of the inorganic fine particle in the resin composition for the optical packaging material. In a preferable embodiment, the refractive index of the core or the clad is controlled by changing the content of the inorganic fine particle having the average inertia radius of 50 nm or smaller and the same resin components are used. Since the resin components of the optical packaging material to be used for the core and the clad are same and therefore the adhesion between the core and the clad becomes good and thus an optical waveguide with high reliability can be obtained. In this case, the content of the inorganic fine particle having an average inertia radius of 50 nm or smaller is preferably 1% or more by weight and 50% or less by weight, and more preferably 5% or more by weight and 40% or less by weight in the resin composition for the optical packaging material. If the content of the inorganic fine particle is from 1% to 50% by weight, the transparency of the core and the clad of the optical waveguide is ensured and concurrently, the refractive index for the core and the clad are suitable.

The optical waveguide device is defined as a device having an optical waveguide. The optical waveguide generally has a plane structure comprising a core and a clad covering the core wherein the light transmits through the core while being repeatedly reflected by the interface between the core and the clad based on the difference of the refractive indexes of the core and the clad. For the clad, generally a material having a smaller refractive index than that of a material for the core is used. There are some types of optical waveguides: an embedding type optical waveguide comprising a lower part clad, an upper part clad, and a linear core which is embedded between the lower part clad and the upper part clad; a ridge type optical waveguide comprising a core for which a core material having a refractive index higher than that of air is selected and an upper part clad for which air is used in the embedded type optical waveguide; and a slab type optical waveguide comprising a core for which a plate-like core is laminated and interposed between the plate-like upper part clad and lower part clad. As described above, the optical waveguide may be formed with a waveguide circuit combining any one of a straight waveguide, a bent waveguide, a crossing waveguide, a branching waveguide.

The method for preparing the optical waveguide device in the present invention is not particularly limited and the following methods can be exemplified.

(A) At first, a master die having a groove corresponding to the core is produced and a die for molding a lower part clad is produced using the master die. In this case, the groove pattern corresponding to the core formed in the master die is transferred to the die for molding the lower part clad. Next, using the die for molding the lower part clad, the lower part clad is molded. The groove pattern corresponding to the core which is transferred to the die for molding the lower part clad is further transferred to the lower part clad. The groove formed in the lower part clad and corresponding to the core is filled with the resin composition for the core and the resin composition is cured to form the core. Then the resin composition for an upper part clad is applied and cured to form the upper part clad.
(B) A lower part clad is produced by applying the resin composition for the lower part clad to a substrate such as a silicon wafer, quartz, and the resin and curing the resin composition. The resin composition for the core is applied to the obtained lower part clad and cured. A photoresist is applied to the core film after curing the resin composition for the core, and then using the applied photomask having an optical circuit pattern, exposure and development are carried out to form the optical circuit pattern. Next, the portions of the core film where the photoresist is not put are selectively removed by dry etching (e.g. RIE reactive ion etching) or wet etching using an acid, an alkali, or an organic solvent and the like and then the photoresist is removed. Thereafter, the resin composition for the upper part clad is applied and cured to obtain an (embedded type optical waveguide.
(C) A lower part clad is produced by applying the resin composition for the lower part clad to a substrate such as a silicon wafer, quartz, and the resin and curing the resin composition. The resin composition for the core is applied to the obtained lower part clad. UV rays are irradiated through a photomask bearing an optical circuit pattern to selectively cure the core layer. The uncured resin composition for the core (the portions where the UV rays are not radiated) is removed by an acid, an alkali or an organic solvent and then the resin composition for the upper part clad is applied and cured to obtain an embedded type optical waveguide.
(D) A master die having a projection reversely corresponding to the groove for the core is produced and a silicone resin is poured to the master die to produce a die for molding the core. A lower part clad of the resin is formed on an arbitrary substrate by a conventional method and the above-mentioned die for molding the core is contacted to the obtained lower part clad. At that time, it is preferable to apply the pressure from the back side of the substrate or to reduce the pressure of the groove portions of the die for molding the core by a vacuum pump. Next, the groove portions formed between the lower part clad and the die for molding the core contacted thereto are filled with the resin composition for the core and cured and then the die for molding the core is removed and then the resin composition for the upper part clad is applied and molded to obtain an optical waveguide device.
(E) After a release layer is formed properly on a projected type master die, the resin composition for the lower part clad is applied. Where necessary, a transparent substrate is put on the applied resin composition for the lower part clad and UV is irradiated to cure the resin composition. At that time, the resin composition for the lower part clad may be pressurized. The cured lower part clad is separated from the master die (if necessary, by immersing in water, an acid, an alkali, or an organic solvent). The grooves formed in the lower part clad are filled with the resin composition for the core and the resin composition is cured and then the resin composition for the upper part clad is applied and cured to form the upper part clad.
(F) Other than the above-mentioned methods, a method which comprises directly forming the resin composition for the core in the lower part clad by a screen printing, an ink jet printing technique and a method which comprises directly forming the grooves in the lower part clad and embedding the core can be exemplified.

In the methods (A) to (F), as a method for filling or applying the resin composition for the clad and the resin composition for the core, a conventional method such as spin coating, bar coating, dip coating, and spray coating can be appropriately selected.

Hereinafter, based on the embodiment where the resin composition for the optical packaging material of the present invention is used for both the core and the clad, the method for producing the optical waveguide described in (A) will be described in detail, however it is not construed that the invention be limited to the embodiment.

At first, a two-component mixing type silicone resin is applied to a master substrate produced by forming grooves corresponding to the core on a substrate such as quartz or silicon and cured to produce a die for molding a clad made of the silicone material with the grooves formed on the surface thereof. The reason for forming the die for molding the clad made of the silicone material is to improve the die releasing property of the clad to be molded. As the silicone material, a curable silicone material such as a curable silicone rubber oligomer or monomer, and a curable silicon resin oligomer or monomer which is cured to be silicone rubber or silicone resin are preferable and a curable polysiloxane is more preferable. The curable polysiloxane may include a one-component type or two-component type and also may include a thermosetting type or a room temperature curing type. As the curable silicone material, a so-called liquid silicone is generally used and a two-component mixing type material to be used in combination with a curing agent is more preferable. Because it is excellent in the release property and mechanical strength. Further, if the curable silicone material with a low viscosity is used, the processibility, e.g. removal of foams produced at the time of the production, or die formation with high precision of transfer patterns is made possible.

Specific examples of the preferable curable silicone material are alkylsiloxane, alkenylsiloxane, alkylalkenylsiloxane, and polyalkyl hydrogen siloxane. Especially, a two-component mixture containing the alkylalkenylsiloxane and alkyl hydrogen siloxane and having a low viscosity and curable at a room temperature is preferable in terms of the release property and processibility.

Next, using the die for molding the clad made of the silicone material, a clad is molded. Practically, the resin composition for the optical packaging material of the present invention is applied to the side of the die for molding the clad made of the silicone material on which side the grooves are formed, in such a manner that the grooves are filled with the resin composition. A flat substrate is further laminated thereon and the resin composition for the optical packaging material of the present invention is cured to obtain the clad. A pattern of grooves corresponding to the core are transferred to the surface of the obtained clad.

Next, the core is formed in the grooves formed in the surface of the clad. The method for forming the core includes a method which comprises filling the resin composition for the optical packaging material of the present invention in the grooves formed in the clad surface and curing the resin composition to obtain the core. Examples of the method for filling the resin composition for the optical packaging material in the grooves formed in the clad surface are a spin coating method, a bar coating method, a dip coating method, and a spray coating method. After forming the core on the clad, an upper part clad is formed to cover the core on the side of the clad on which side the core is formed. The method for forming the upper part clad, without limitation, for example includes a method which comprises applying the resin composition for the optical packaging material of the present invention to the side of the clad on which side the core is formed and curing the resin composition to form the upper part clad layer.

In the case the resin composition for the optical packaging material of the present invention is used for substrates (corresponding to the first substrate and the second substrate in FIG. 5) of the optical waveguide device, the resin composition for the optical packaging material of the present invention is press-molded to produce a disc-like flat plate with a diameter of 3 to 8 inch and a thickness of 500 μm. A waveguide circuit of quartz type or polymer type are formed on the substrate in a conventional manner. After forming the optical waveguide circuit, a photo-/thermo-setting adhesive is applied to the optical waveguide circuit and a second substrate is put thereon and then the adhesive is cured. After curing the adhesive, the resulting body is cut into a desired size by a dicing saw or the like to obtain an optical waveguide. Alternatively, at first, a first substrate may be produce by cutting the flat plate with a diameter of 3 to 8 inch and a thickness of 500 μm into a prescribed size and then the same process as described above is carried out to produce the optical waveguide.

### EXAMPLES

The invention will be described in detail with the following examples. However, it is not intended that the invention be limited to the described examples. Modifications and embodiments are included in the present invention without departing from the spirit and scope of the present invention.

### [Measurement of Particle Size Distribution and Weight Average Particle Size of Inorganic Fine Particle]

With respect to the resin compositions A and B, which will be described later, the compositions were crushed in a mortar and screened through a 300 mesh-sieve and the particle passed through the sieve were packed in a capillary made of quartz glass with 1 mmφ under vibrating condition to obtain measurement samples. With respect to resins C, D, E and F, which will be described later, the resins were heated to 60° C. and packed in a capillary made of quartz glass with 1 mmφ under vibrating condition to obtain measurement samples. The measurement samples were subjected to a small angle x-ray scattering under the following conditions:

Measurement conditions: the apparatus employed: RINT-2400 (manufactured by Rigaku Denki Sha).
Incident x-ray was converted to be monochrome by passing it through a multilayer membrane mirror monochromator and passed via three slits and then irradiated to each measurement sample. The scattered x-rays were detected by a scintillation counter installed at position with 250 mm camera length through a vacuum path. Measurement conditions

X-ray used: CuKα rays,

Tube voltage and tube current: 40 kV, 200 mA,

Operation method: Fixed time method,

Measurement method: transmission method (2θ single operation),

Operation range 20, step intervals: 0.1 to 5.0 deg, 0.01 deg, and

Counting time: 5.0 second.

After the measurement, a guinier plot was produced by Faukuchen method from the obtained scattering profile and the average inertia radius was calculated.

### [Measurement Method of Coefficient of Thermal Expansion]

The coefficient of thermal expansion was measured by the following conditions using a TMA measurement (TMA 50, manufactured by Shimadzu Corp.):

Atmosphere: N₂, temperature: 20 to 200° C.; and temperature increasing speed 10° C./min.

### [Measurement of Refractive Index]

Each resin composition for the optical packaging material was mixed with 1% by weight of a cationic epoxy curing agent (San-Aid SI 100 L, manufactured by Sanshin Chemical Industry Co., Ltd.) and applied to a Si wafer to form a 5 μm-thick film at a proper rotation speed by spin coating. The wafer with the film formed was put in an oven controlled to be in nitrogen atmosphere and the temperature was raised to 110° C. and kept for 1 hour and further raised to 180° C. and kept for 1 hour to obtain a sample for measuring the refractive index. The obtained each resin composition was measured by a prism coupler SPA-4000 (manufactured by SAIRON TECHNOLOGY Co., Ltd.) to determine the refractive index. The measurement wavelength was 830 nm.

### [Synthesis of the Resin Composition for the Optical Packaging Material]

### Synthesis Example 1

Phenol 432.9 g, benzoguanamine 172.2 g, and a 37% formaldehyde solution 179.2 g were charged into a 1 L four-neck flask equipped with a gas inlet, a Dean-Stark trap, and a stirring rod and ammonia water 9 mL was slow-added while stirring the white liquid at 60° C. in nitrogen current. When the reaction liquid became transparent, the liquid was heated to 80° C. and kept for 4 hours at that temperature while stirring, and then heated again. While collecting the produced water which started being distilled around 100° C. in the trap, the reaction liquid was heated to 180° C. and kept for 4 hours. After 160 g of water was collected, the water production was stopped and the reaction liquid was cooled to 60° C. Subsequently, methanol 100 g and acetic acid 8.3 g were added. Next, two PTFE tubes were inserted into the reaction liquid in the four-neck flask and tetramethoxysilane 210.1 g and water 99.4 g were added for 4 hours through the separate tubes by using roller pumps while keeping the temperature at 20° C. After the supply, the reaction liquid was kept at 60° C. for 4 hours. Further, the reaction liquid was heated again in nitrogen current. While collecting residual water and formed methanol which started being distilled around 80° C. in the trap, the reaction liquid was stirred and heated to 180° C. and residual phenol was removed in reduced pressure by distillation and the reaction liquid was cooled to obtain a milky white solid resin composition A. The yield was 486 g, the thermal softening temperature was 98° C., the hydroxyl value was 204 g/mol, and the content of inorganic fine particle was 16.5%.

### Synthesis Example 2

p-xylene glycol 302.6 g, phenol 687.0 g, and p-toluenesulfonic acid 12.6 g were charged into a 2 L four-neck flask equipped with a gas inlet, a Dean-Stark trap, and a stirring rod and heating was started in nitrogen current. Around 115° C., water started being produced. While collecting the formed water in the trap, the reaction liquid was heated to 150° C. and kept for 6 hours. When water 79 g was collected, the water production was stopped and therefore, the reaction liquid was cooled to 60° C., and then diglyme 176 g was added. Next, two PTFE tubes were inserted into the reaction liquid in the four-neck flask and tetramethoxysilane 336.4 g and water 157.8 g were added for 4 hours through the separate tubes by using roller pumps while keeping the temperature at 20° C.

After the supply, the reaction liquid was kept at 60° C. for 4 hours. Further, the reaction liquid was heated again and continuously stirred to 180° C. in nitrogen current while collecting un-reacted water, methanol, and diglyme which started being distilled around 80° C. in the trap and un-reacted phenol was removed in reduced pressure by distillation and the reaction liquid was cooled to obtain a milky white solid resin composition B. The yield was 619 g, the thermal softening temperature was 52° C., the hydroxyl value was 193 g/mol, and the content of inorganic fine particles was 20.7%.

### Synthesis Example 3

A cresol novolak type epoxy resin (trade name: EOCN-102S, manufactured by Nippon Kayaku Co., Ltd.; epoxy equivalent 210 g/mol) 168 g and ethylene glycol diacrylate 122.3 g were charged into a 500 mL four-neck flask equipped with a gas inlet, a Dean-Stark trap, and a stirring rod and dissolved while stirring at 80° C. Subsequently, 4-hydroxy-2,2,6,6-tetramethylpiperidin-1-oxyl 0.011 g and tetraphenylphosphonium bromide 1.01 g were added and acrylic acid 59.1 g was slow-added for 2 hours at 110° C. under air current. After the supply, the reaction liquid was stirred at 115° C. for 6 hours in air current and the reaction liquid was cooled to 40° C. after confirming the reaction acid value to be 7 mgKOH/g or lower. Next, two PTFE tubes were inserted into the reaction liquid in the four-neck flask and tetramethoxysilane 121.78 g and 5% ammonia water 57.6 g were added for 4 hours through the separate tubes by using roller pumps while keeping the temperature at 40° C. After the supply, the reaction liquid was kept at 60° C. for 4 hours. Further, the reaction liquid was heated again at 650 mmHg in air current, and continuously stirred to 120° C. while collecting un-reacted water and methanol which started being distilled around 65° C. in the trap. On completion of the distillation, the reaction liquid was cooled to a room temperature to obtain a milk white liquid phase resin composition C. The yield was 398 g, the content of inorganic fine particles was 13.6%, and the nonvolatile component content was 72%.

### Synthesis Example 4

An alicyclic epoxy resin (trade name: CEL 2021P, manufactured by Daicel Chem. Ind. Ltd.) 165.65 g and propylene glycol methyl ether acetate 165.65 g were charged into a 500 mL four-neck flask equipped with a gas inlet, a cooling tube, and a stirring rod and stirred well at a room temperature and when the mixture became a uniform solution, tetramethoxysilane 82.01 g and 3-glycidoxypropyltrimethoxysilane 54.57 g were added and stirred at a room temperature to obtain a uniform solution. While stirring the mixed solution, ion-exchanged water 51.31 g was slow added at a room temperature for 2 hours and successively the mixed solution was heated to 80° C. and kept for 4 hours. Next, triethyl phosphate 3.20 g was added and the solution was kept for 2 hours and methanol and propylene glycol methyl ether acetate as volatile components were removed by distillation under reduced pressure and after cooling the solution, a colorless transparent viscous liquid, resin composition D, was obtained. The yield was 260 g, the epoxy equivalent was 171 g/mol, and the content of inorganic fine particles was 29.5% by weight.

### Synthesis Example 5

A resin composition E was obtained in the same manner as Synthesis example 3, except for eliminating the step of adding tetramethoxysilane and 5% ammonia water to disperse the inorganic fine particle. The yield was 331 g, the content of the inorganic fine particle was 0%, and the content of the nonvolatile components 65%.

### Synthesis Example 6

An alicyclic liquid phase epoxy resin (trade name: Celloxide CEL 2021P, manufactured by Daicel Chem. Ind. Ltd.) 164.74 g and propylene glycol methyl ether acetate 164.74 g were charged into a 500 mL four-neck flask equipped with a gas inlet, a cooling tube, and a stirring rod and stirred well at a room temperature and when the mixture became a uniform solution, tetramethoxysilane 52.55 g, phenyltrimethoxysilane 41.07 g and 3-glycidoxypropyltrimethoxysilane 32.64 g were added and stirred at a room temperature to obtain a uniform solution. While stirring the mixed solution, ion-exchanged water 43.55 g was slow-added at a room temperature for 2 hours and successively the mixed solution was heated to 80° C. and kept for 4 hours. Next, triethyl phosphite 0.76 g was added and the solution was kept for 2 hours and methanol and propylene glycol methyl ether acetate as volatile components were removed by distillation under reduced pressure and after cooling the solution, a colorless transparent viscous liquid, resin composition F was obtained. The yield was 240 g, the epoxy equivalent was 219 g/mol, the content of the inorganic fine particle was 29.5% by weight, and the viscosity was 6,810 mPa·s at 25° C.

### Synthesis Example 7

A bisphenol A type epoxy resin (trade name: Epikote 828EL, manufactured by Japan Epoxy Resin Co., Ltd.) 206.08 g and propylene glycol methyl ether acetate 206.08 g were charged into a 500 mL four-neck flask equipped with a gas inlet, a cooling tube, and a stirring rod and stirred well at a room temperature and when the mixture became a uniform solution, tetramethoxysilane 27.07 g, phenyltrimethoxysilane 21.16 g, and 3-glycidoxypropyltrimethoxysilane 16.81 g were added and stirred at a room temperature to obtain a uniform solution. While stirring the mixed solution, ion-exchanged water 22.43 g was slow-added at a room temperature for 2 hours and successively the mixed solution was heated to 80° C. and kept for 4 hours. Next, triethyl phosphite 0.38 g was added and the solution was kept for 2 hours and methanol and propylene glycol methyl ether acetate as volatile components were removed by distillation under reduced pressure and after cooling the solution, a colorless transparent viscous liquid, resin composition G was obtained. The yield was 245 g, the epoxy equivalent was 190 g/mol, the content of the inorganic fine particle was 15.3% by weight, and the viscosity was 4,330 mPa·s at 25° C.

With respect to the resin compositions A to G, the average inertia radius of the inorganic fine particle was measured and the results are collectively shown in Table 1.

TABLE 1

| Resin | Content | Average inertia |
|---|---|---|
| composition | (% by weight) | radius (nm) |
| A | 16.5 | 15.3 |
| B | 20.7 | 18.8 |
| C | 13.6 | 12.1 |
| D | 29.5 | 11.8 |
| E | 0 | — |
| F | 29.5 | 8.3 |
| G | 15.3 | 10.3 |

From Table 1, it is found that the inorganic fine particle with an average inertia radius of 50 nm or smaller were dispersed in the resin compositions A to D and F to G.

### [Production of Resin Composition for Optical Fiber Array Substrate]

The resin compositions A and B obtained in the above-described manner were formulated as shown in Table 2 and kneaded by a heating type roll kneader in conditions of roll surface temperature of 70° C. and roll pressure of 3 to 5 MPa for 10 minutes and the obtained kneaded mixtures were cooled by immersion in liquefied nitrogen to obtain the resin compositions 1 to 4 for the optical fiber array substrate.

The above-mentioned resin compositions 1 to 4 for the optical packaging were press-molded in conditions of 180° C. and 8 MPa for 5 minutes. After the press molding, the molded products were removed form dies and post-cured at 180° C. for 5 hours in an oven in which the gas was replace with nitrogen to produce 3 mm-thick flat plates (optical packaging materials). The obtained flat plates were subjected to TMA measurement by TMA 50 manufactured by Shimadzu Corp. At the same time, the plates were subjected to flame retardancy test according to UL-94. The results are collectively shown in Table 2.

TABLE 2

| | Resin composition for optical packaging | | | |
|---|---|---|---|---|
| | material (for optical fiber array substrate) | | | |
| | 1 | 2 | 3 | 4 |
| Epoxy resin | 6.23 | 6.54 | 44.73 | 6.2 |
| Resin composition A | 6.88 | — | 46.41 | — |
| Resin composition B | — | 6.79 | — | — |
| Phenol aralkyl resin | — | — | — | 5.73 |
| Fused silica A | 86.35 | 86.07 | 4.78 | 87.48 |
| Curing promoting agent | 0.12 | 0.12 | 0.82 | 0.12 |
| Carnauba wax | 0.24 | 0.24 | 1.63 | 0.24 |
| Coupling agent | 0.24 | 0.24 | 1.63 | 0.24 |
| Physical properties | — | — | — | — |
| of cured product | | | | |
| Silica content in cured | 88 | 88 | 15 | 88 |
| product (% by weight) | | | | |
| Tg (TMA measurement, | 112 | 110 | 115 | 105 |
| ° C.) | | | | |
| CTE1 (TMA | 6.8 | 8.9 | 38.5 | 12.4 |
| measurement, ppm) | | | | |
| CTE2 (TMA | 19.5 | 30.5 | 162 | 36.3 |
| measurement, ppm) | | | | |
| Flame retardancy | V-0 | V-0 | V-1 | V-2 |
| Remark | Example | Example | Example | Compar- |
| | | | | ative |
| | | | | Example |

Epoxy resin: Epikote 828 EL, manufactured by Japan Epoxy Resin Co., Ltd.
Phenol aralkyl resin: XLC 3L, manufactured by Mitsubishi Chemical Corp.
Fused silica: FB-8S (average particle diameter 6.5 μm), manufactured by Denki Kagaku Kogyo K.K.
Curing-promoting agent: 2-phenyl-4-methyl-5-hydroxymethylimidazole, manufactured by Shikoku Chemicals Corp.
Coupling agent: A-187, manufactured by Nippon Unicar Co., Ltd.
CTE1: coefficient of thermal expansion (Tg or lower)
CTE2: coefficient of thermal expansion (exceeding Tg)

In comparison with the obtained flat plates having the same silica content, the molded bodies of the resin compositions 1 and 2 of Examples were found to have the coefficient of thermal expansion smaller than that of the molded body of the resin composition 4 of Comparative Example. Especially, the coefficient of thermal expansion of the molded bodies of the resin compositions 1 and 2 at Tg or lower was approximately same as that of quartz which has conventionally been used. On the other hand, the resin composition 4 of Comparative Example didn't have a small coefficient of thermal expansion and low flame retardancy, although the packed ratio of the inorganic compound was increased.

From these results, it is supposed that use of the resin composition for the optical packaging material of the present invention enhances the reliability of the optical fiber packaging. Also, the coefficient of thermal expansion (CTE1) can be adjusted to be same as that of polyimide by decreasing the fused silica addition amount just like the case of the resin composition 3 for the optical packaging material, resulting in the improvement of the reliability of mounting the optical packaging component made and optical fibers of plastics made of plastic. Further, a comparison of the resin compositions 1 to 3 and a comparison of resin compositions 3 and 4 in the examples indicated that the flame retardancy can be improved by adding the inorganic fine particle in the resin composition.

### [Production of the Resin Composition for the Optical Fiber Array Adhesive]

The resin compositions C to E obtained in the above-mentioned manner were formulated as shown in Table 3 and kneaded three times with a kneader having three rolls at a room temperature and under the roll pressure of 3 to 5 MPa and filtered through a 100 mesh filter cloth made of a stainless steel to obtain the resin compositions 5 to 8 for the optical fiber array adhesive.

Each of the resin compositions 5 to 8 for the optical fiber array adhesive was applied in 200 μm thickness oil a glass plate and a Tetoron film was put on the surface and cured by irradiating ultraviolet rays of 7 J/cm² for 30 minutes using a high pressure mercury lamp. The Tetoron film was peeled off from the obtained cured product to prepare a sample for TMA. Each sample was subjected to the TMA measurement.

Each of the resin compositions 5 to 8 for the optical fiber array adhesive was applied in 200 μm thickness on a 3 mm-thick glass plate, which was degreased by acetone and dried, and then another 3 mm-thick glass plate which was degreased by acetone and dried was put thereon and the resin composition was cured by irradiating ultraviolet rays of 7 J/cm² for 30 minutes using a high pressure mercury lamp to obtain a sample for adhesion strength measurement. Each sample was subjected to the adhesion strength measurement. The results of the coefficient of thermal expansion and shear adhesive strength are collectively shown in Table 3.

TABLE 3

| | Resin composition for optical | | | |
|---|---|---|---|---|
| | packaging material (for adhesive) | | | |
| | 5 | 6 | 7 | 8 |
| Resin composition C | 100 | — | — | — |
| Resin composition D | — | 100 | — | — |
| Resin composition E | — | — | 100 | — |
| Alicyclic epoxy resin | — | — | — | 100 |
| Photoradical | 5 | — | 5 | — |
| generating agent | | | | |
| Photo acid generating | — | 5 | — | 5 |
| agent | | | | |
| Fused silica B | 50 | 50 | 50 | 50 |
| Physical properties of | — | — | — | — |
| cured product | | | | |
| CTE1 (TMA | 32.7 | 35.4 | 43 | 48.1 |
| measurement, ppm) | | | | |
| shear adhesive strength | 156 | 214 | 105 | 179 |
| (kgf/cm²) | | | | |
| Remark | Example | Example | Example | Comparative |
| | | | | Example |

Photoradical generating agent: Irgacure 184, manufactured by Ciba Speciality Chemicals
Photoacid generating agent: Adecaoptomer SP 170, manufactured by Asahi Denka Kogyo K.K.,
Fused silica B: E-2 (average particle size 0.5 μm) manufactured by Admatechs Co., Ltd.,
Alicyclic epoxy resin: trade name, CEL 2021 P, manufactured by Daicel Chem. Ind. Ltd.

### [Production of the Optical Fiber Arrays A to C]

(1) The resin compositions 1 to 3 for the optical fiber array substrate were press-molded at the conditions of 180° C. and 8 MPa for 5 minutes to produce fiber array substrates A to C (10 mm×5 mm×1.5 mm) each having 32 V-shaped grooves. As a die, an upper die where a group of 32 projected hill type stripes having a top angle of about 90° for forming V-shaped grooves on the fiber array substrate are formed with an interval of 10 mm was used. As a lower die, a die subjected to mirror treatment was used. The above-mentioned resin compositions 1 to 3 were drawn to sheet-like shape with 1 mm thickness and then cooled and cut into a size of 10 mm×5 mm×1 mm size to produce the sheets A′ to C′ for an optical fiber array substrate (the second substrate).
(2) Next, optical fibers made of quartz and having a clad diameter of 125 μm and of which fiber the resin coating was partially peeled were arranged at an interval of 250 μm while the end faces being arranged evenly by an aligner. While being held by the aligner, the optical fibers were placed in the respective V-shaped grooves of the V-shaped groove substrates A and B. Also, optical fibers made of a plastic and having a clad diameter of 125 μm and of which fiber the resin coating was partially peeled were arranged at an interval of 250 μm while the end faces being arranged evenly by an aligner. While being held by the aligner, the optical fibers were placed in the V-shaped grooves of the V-shaped groove substrate C.

The sheets A′ to C′ for the optical fiber array substrate (the second substrate) were respectively put on the open parts of the top faces of the substrates A to C having the V-shaped grooves where the optical fibers were placed. The resulting substrate units were pressure-bonded by a heat press in conditions of a temperature from a room temperature to 100° C. and the pressure of 0.4 MPa for 5 minutes. After the press, the respective units were post cured at 180° C. for 5 hours in an oven in which gas was replaced with nitrogen to obtain optical fiber arrays A to C.

The obtained optical fiber arrays A to C were observed by a microscope (High Scope KH-2700, manufactured by Hirox Co.) to evaluate the state of the placed optical fibers. With respect to the optical fiber arrays A to C, the placed positions of the optical fibers were found within 3% of the estimated value according to the press die design, showing that the optical fibers were placed at prescribed positions in a high accuracy.

### [Production of Optical Fiber Arrays D and E]

(1) Substrates D and E for the optical fiber array (10 mm×5 mm×1.5 mm) in which 32 V-shaped grooves were formed were produced from the resin compositions 1 and 2 by the same method as that for the optical fiber arrays A to C. Also, adhesives 9 and 10 for the optical fiber array shown in the following Table 4 were produced.

TABLE 4

Adhesive for
optical fiber
array

| | 9 | 10 |
|---|---|---|
| Resin composition C | 100 | — |
| Resin composition D | — | 100 |
| Photoradical generating agent | 5 | — |
| Photo acid generating agent | — | 5 |

(2) Next, optical fibers made of PMMA (manufactured by Hitachi Cable Ltd.) and having a clad diameter of 125 μm and of which fiber the resin coating was partially peeled were arranged at an interval of 250 μm while the end faces being arranged evenly by an aligner. While being held by the aligner, the optical fibers were placed in the respective V-shaped grooves D and E of the substrates D and E obtained in the manner as described above. The adhesives for the optical fiber array 9 and 10 were respectively applied to the open parts of the top faces of the substrates D and E having the V-shaped grooves where the optical fibers are placed. After it was confirmed that the adhesives filled the spaces between the V-shaped grooves and the optical fibers, flat plates made of quartz with a size of 10 mm×5 mm×1 mm were put there on and the adhesives were cured by irradiating ultraviolet rays of 7 J/cm² for 30 minutes using a high pressure mercury lamp to obtain the optical fiber arrays D and E.

The obtained optical fiber arrays D and E were observed by a microscope (High Scope KH-2700, manufactured by Hirox Co.) to evaluate the state of the placed optical fibers. With respect to the optical fiber arrays D and E, the placed positions of the optical fibers were found within 3% of the estimated value according to the press die design, showing that the optical fibers were housed at prescribed positions in a high accuracy.

### [Refractive Index of the Resin Composition for the Optical Waveguide]

The results of refractive index measurement of the resin compositions F and G, CEL 2021P, manufactured by Daicel Chem. Ind. Ltd., and Epikote 828EL, manufactured by Japan Epoxy Resin Co., Ltd. are shown in Table 5.

TABLE 5

| | Content of inorganic | Refractive | |
|---|---|---|---|
| Material | fine particles (%) | index | ΔnD (%) |
| Celloxide CEL 2021P | — | 1.5193 | — |
| Resin composition F | 29.5 | 1.4995 | 1.30% |
| Epikote 828EL | — | 1.5724 | — |
| Resin composition G | 15.3 | 1.562 | 0.70% |

From Table 5, a comparison of the refractive indexes between CEL 2021P, manufactured by Daicel Chem. Ind. Ltd., and the resin composition F indicated that the refractive index was lowered by about 1.3% by containing the inorganic fine particle with an average inertia radius of 50 nm or smaller in an amount of about 30%. Also, a comparison of the refractive indexes between Epikote 828EL, manufactured by Japan Epoxy Resin Co., Ltd., and the resin composition G indicated that a refractive index was lowered by about 0.7% by containing the inorganic fine particle with an average inertia radius of 50 nm or smaller in an amount of about 15%. From these results, it is understood that the refractive index of the optical packaging material obtained by curing the resin composition for the optical packaging material can be controlled depending on the content of the inorganic fine particle with an average inertia radius of 50 nm or smaller.

### [Production of Optical Waveguide Device]

A silicon substrate with a width of 5 cm, a length of 5 cm, and a thickness of 525 μm in which 40 grooves with a width of 200 μm and a depth of 200 μm were formed at an interval of 1 mm was used as a master die and a two-component type silicone resin (manufactured by Shin Etsu Silicone Co., Ltd.) was applied to the master die and kept at room temperature for 24 hours for curing and the master die was removed to produce a die for molding the clad (made of silicone rubber).

Next, the resin composition for the clad and the resin composition for the core formulated as shown in Table 6 were used to form the clad and the core. At first, a proper amount of each resin composition was poured in the previously produced die for molding the clad and a quartz (SiO₂) substrate was put thereon and the resin composition was cured by UV radiation from the upper side and by heat treatment. The UV curing was carried out under conditions of ultraviolet rays with wavelength of 300 nm to 400 nm at the energy density of 10 mW/cm² for 30 minute radiation time and the heat treatment was carried out in conditions of 100° C.×30 minutes.

Subsequently, the cured clad attached to the quartz substrate was separated from the die for molding the clad (made of silicone rubber). Each resin composition for the core was charged only in the groove parts of the obtained clad having the grooves and cured by UV radiation to produce the core with 200 μm square. Finally, the resin composition for the clad was applied to the core-formed face by spin coating and then cured by UV radiation and by heat treatment in the same conditions described above to form the upper part clad with a thickness of 100 μm. The assembled body was cut in a length of 4 cm to obtain each optical waveguide device 1 to 4. Each or the obtained optical waveguide devices was measured to determine the optical transmission loss (including connection loss) of 850 nm wavelength in 4 cm and loss fluctuation at 850 nm wavelength after humidifying treatment of 85° C.×85% RH×200 hours. The results of the optical transmission loss and loss fluctuation measurement are collectively shown in Table 6.

TABLE 6

| | | Optical | Optical | | |
|---|---|---|---|---|---|
| | | wave- | wave- | Optical | Optical |
| | | guide | guide | waveguide | waveguide |
| | | device 1 | device 2 | device 3 | device 4 |
| Clad | Resin | — | 100 | 100 | — |
| | composition F | | | | |
| | CEL2021P | 100 | — | — | 100 |
| | SI100L | 2 | 2 | 2 | 2 |
| | DBA | 0.1 | 0.1 | 0.1 | 0.1 |
| Core | Resin | 100 | — | 100 | — |
| | composition G | | | | |
| | Epikote 828EL | — | 100 | — | 100 |
| | SI100L | 2 | 2 | 2 | 2 |
| | DBA | 0.1 | 0.1 | 0.1 | 0.1 |
| Properties | Optical | 0.1 | 0.1 | 0.1 | 0.1 |
| | transmission | | | | |
| | loss (dB/cm) | | | | |
| | Loss | 0.4 | 0.3 | 0.2 | 0.8 |
| | fluctuation | | | | |
| | (dB) | | | | |

| | | | | |
|---|---|---|---|---|
| Remark | Exam- | Exam- | Example | Comparative |
| | ple | ple | | Example |

Photoacid generating agent: San-Aid SI100L, manufactured by Sanshin Chemical Industry Co., Ltd.
Sensitizer: DBA manufactured by Kawasaki Kasei Co., Ltd.

The optical waveguide devices 1 to 3 were produced by using the resin composition for the optical packaging material of the present invention for either the clad or the core. It can be understood that use of the resin composition of the present invention for either the clad or the core is effective to lower the loss fluctuation after humidifying treatment. Thus, this result indicated the improvement of the reliability of the optical waveguide. On the other hand, the optical waveguide 4 using a conventional material was found having increased loss fluctuation.

### INDUSTRIAL APPLICABILITY

The present invention is suitable for the optical packaging component to be used for the optical fiber communication, the optical module, and the optical packaging material suitable to be used for them.

1. A resin composition for an optical packaging material comprising a resin and an inorganic fine particle, wherein the inorganic fine particle is a hydrolyzed condensate of an alkoxide compound and/or a carboxylic acid salt compound and has an average inertia radius of 50 nm or smaller.

2. The resin composition for the optical packaging material according to claim 1, wherein the resin is a thermosetting resin or a photocurable resin.

3. The resin composition for the optical packaging material according to claim 1, wherein the resin composition further contains 2% (inclusive) to 95% (exclusive) by weight of an inorganic compound having an average particle size of 0.1 μm to 100 μm.

4. An optical packaging material obtained by curing the resin composition for the optical packaging material according to claim 1.

5. A molded body of the optical packaging material according to claim 4.

6. The molded body of the optical packaging material according to claim 5 having a coefficient of thermal expansion of 80 ppm or lower at a temperature of a glass transition temperature or lower.

7. A halogen-free resin molded body for an optical packaging material, having flame retardancy of V-1 or higher defined by UL-94 and a coefficient of thermal expansion of 80 ppm or lower at a temperature of a glass transition temperature or lower thereof.

8. An optical packaging component using the optical packaging material and/or the molded body of the optical packaging material according to claim 4.

9. The optical packaging component according to claim 8, comprising any one of an optical fiber array, a micro hole array, or an optical waveguide device.

10. An optical module comprising the optical packaging component according to claim 8.

11. A method for preparing a molded body of an optical packaging material comprising,
pressure molding a resin composition for an optical packaging material comprising a resin and an inorganic fine particle wherein the inorganic fine particle is a hydrolyzed condensate of an alkoxide compound and/or a carboxylic acid salt compound and has an average inertia radius of 50 nm or smaller.

12. An optical waveguide device comprising
an optical waveguide having a core and a clad covering the core, wherein at least one of the core and the clad is formed by curing the resin composition for the optical packaging material according to claim 1.

13. The resin composition for the optical packaging material according to claim 2, wherein the resin composition further contains 2% (inclusive) to 95% (exclusive) by weight of an inorganic compound having an average particle size of 0.1 μm to 100 μm.

14. An optical packaging material obtained by curing the resin composition for the optical packaging material according to claim 2.

15. An optical packaging material obtained by curing the resin composition for the optical packaging material according to claim 3.

16. An optical packaging component using the optical packaging material and/or the molded body of the optical packaging material according to claim 5.

17. An optical packaging component using the optical packaging material and/or the molded body of the optical packaging material according to claim 6.

18. An optical packaging component using the optical packaging material and/or the molded body of the optical packaging material according to claim 7.

19. An optical module comprising the optical packaging component according to claim 9.

20. An optical waveguide device comprising
an optical waveguide having a core and a clad covering the core, wherein at least one of the core and the clad is formed by curing the resin composition for the optical packaging material according to claim 2.

21. An optical waveguide device comprising
an optical waveguide having a core and a clad covering the core, wherein at least one of the core and the clad is formed by curing the resin composition for the optical packaging material according to claim 3.
